(19) United States
(12) Patent Application Publication
(10) Pub. No.: US 2016/0013952 A1
(43) Pub. Date: Jan. 14, 2016

(54) RECEPTION DEVICE AND RECEPTION METHOD

(71) Applicants: SHARP KABUSHIKI KAISHA, Osaka-shi, Osaka (JP); OSAKA UNIVERSITY, Osaka (JP)

(72) Inventors: Osamu NAKAMURA, Osaka-shi, Osaka (JP); Hiroki TAKAHASHI, Osaka-shi, Osaka (JP); Jungo GOTO, Osaka-shi, Osaka (JP); Kazunari YOKOMAKURA, Osaka-shi, Osaka (JP); Yasuhiro HAMAGUCHI, Osaka-shi, Osaka (JP); Shinsuke IBI, Suita-shi, Osaka (JP); Seiichi SAMPEI, Suita-shi, Osaka (JP); Shinichi MIYAMOTO, Suita-shi, Osaka (JP)

(73) Assignees: OSAKA UNIVERSITY, Suita-shi, Osaka (JP); SHARP KABUSHIKI KAISHA, Osaka-shi, Osaka (JP)

(21) Appl. No.: 14/771,878

(22) PCT Filed: Feb. 19, 2014
(86) PCT No.: PCT/JP2014/053907

§ 371 Date: Sep. 1, 2015

(30) Foreign Application Priority Data
Mar. 4, 2013 (JP) 2013-042405

(51) Int. Cl. H04L 25/02; H04L 1/00; H04W 88/08; H04L 27/26

(52) U.S. Cl. CPC H04L 25/0222; H04L 27/2647; H04L 1/0047; H04W 88/08

(57) ABSTRACT

A reception unit for receiving a signal representing a bit sequence, a channel estimation unit for estimating channel variation that the received signal undergoes and calculating a channel estimation value representing the channel variation, and a demodulation unit for demodulating the signal by using the channel estimation value and restoring each bit included in the bit sequence represented by the received signal are included, and the demodulation unit performs demodulation of the received signal by using a value indicating magnitude of error included in the channel estimation value.

### BACKGROUND OF THE INVENTION

1. Field of the Invention

The present invention relates to a reception device and a reception method.

This application claims priority based on Japanese Patent Application No. 2013-042405 filed in Japan on Mar. 4, 2013, the content of which is incorporated herein.

2. Description of Related Art

In radio communication, a data signal transmitted from a transmit antenna is reflected and diffracted by a scattering body around the transmit antenna or a receive antenna, and is received by the receive antenna. The signal to be received is influenced in such a manner that radio waves strengthen and attenuate each other by a lot of scattering bodies, which is called fading. A receiver (also referred to as a reception device) needs to compensate for the influence on the data signal caused by fading. In a cellular communication system of third and following generations, such as W-CDMA (Wideband Code Division Multiple Access) or LTE (Long Term Evolution), a pilot signal (a pilot symbol, a reference signal), which is a signal known between a transmitter and receiver, is inserted periodically in a data signal. The receiver (or the reception device) is able to estimate the influence of fading (called propagation channel variation, or simply a propagation channel or a channel in some cases) by using the pilot signal, and by using the estimated channel, compensate for the influence of the fading on the received data signal. The channel estimation makes it possible to transfer data without errors.

For transferring data without errors, error correction coding is generally used in radio communication. With the error correction coding, it is possible to correct error caused in a channel by performing coding with redundancy for a data bit sequence for transmission and performing decoding by using the redundancy with the receiver. In this case, a turbo code, an LDPC code or the like is used for the error correction coding, and a bit LLR (Log Likelihood Ratio) is generally input to such a decoder.

Meanwhile, for example, in OFDM (Orthogonal Frequency Division Multiplexing), when a transmission data signal in a k-th subcarrier is X_{d}(k), a complex channel gain of a channel is H(k), and noise received by the receiver is n_{d}(k), a received signal in the k-th subcarrier Y_{d}(k) at the time of data reception is represented by a following formula 1.

[Expression 1]

Y_{d}(k)=H(k)X_{d}(k)+N_{d}(k) (formula 1)

In the OFDM, since subcarriers are independent from each other, each of them is able to be regarded as a narrow-band single carrier. In order to simplify this description, each formula is represented with lowercase letters and an index of k is omitted to thereby obtain a following formula 2.

[Expression 2]

y_{d}=hx_{d}+n_{d} (formula 2)

When x_{d} is BPSK (Binary Phase Shift keying) and x_{d}={+√Eₛ, −√Eₛ} is provided (where Eₛ is a spectral density of a transmission signal), a bit LLR λₑ is represented by a following formula 3 according to NPL 1.

$$\begin{matrix}[ Expression 3 ] & \\ {λ}_{e} = ln \frac{p ( {y}_{d} \vert {x}_{d} = + \sqrt{{E}_{s}} )}{p ( {y}_{d} \vert {x}_{d} = - \sqrt{{E}_{s}} )} & ( formula 3 )\end{matrix}$$

p(y_{d}|x_{d}=+√Eₛ) represents a probability for a received signal to be y_{d} when the transmission signal x_{d} is +√Eₛ. When the noise n_{d} conforms to a complex Gaussian process with an average of 0 and a noise power spectral density of N₀, p(y_{d}|x_{d}=+√Eₛ) is represented by a following formula 4.

$$\begin{matrix}[ Expression 4 ] & \\ p ( {y}_{d} \vert {x}_{d} = + \sqrt{{E}_{s}} ) = \frac{1}{π {N}_{0}} exp ( - \frac{{\vert {y}_{d} - h \cdot ( + \sqrt{{E}_{s}} ) \vert}^{2}}{{N}_{0}} ) & ( formula 4 )\end{matrix}$$

The formula 3 is able to be modified like a following formula 5 by similarly obtaining such a formula in the case of x_{d}=−√Eₛ.

$$\begin{matrix}[ Expression 5 ] & \\ \begin{matrix}{λ}_{e} = ln \frac{\frac{1}{π {N}_{0}} exp ( - \frac{{\vert {y}_{d} - \sqrt{{E}_{s}} h \vert}^{2}}{{N}_{0}} )}{\frac{1}{π {N}_{0}} exp ( - \frac{{\vert {y}_{d} + \sqrt{{E}_{s}} h \vert}^{2}}{{N}_{0}} )} \\ = \frac{4 \sqrt{{E}_{s}}}{{N}_{0}} Re [ {h}^{*} {y}_{d} ]\end{matrix} & ( formula 5 )\end{matrix}$$

In this manner, when the transmission signal is the BPSK, the bit LLR is able to be calculated based on a result that the received signal y_{d} is multiplied by a complex conjugate h* of a channel h. Further, error correction decoding is able to be performed by inputting the obtained bit LLR to a decoder.

Though the formula 5 needs information concerning a complex channel gain h, a channel applied to data actually is unknown. Thus, NPL 2 describes that a reception device estimates a channel gain by using a pilot signal which is transmitted with data by a transmission device and uses the estimated value instead of the channel gain applied to the data actually.

### CITATION LIST

### Non Patent Literatures

NPL 1: L. Hanzo, T. H. Liew, B. L. Yeap, Turbo Coding, Turbo Equalisation and Space-Time coding for Transmission over Fading Channels, IEEE Press-John Wiley.

NPL 2: S. Ferrara, M. Nicoli, U. Spagnolini, “Soft-iterative estimation of structured channels: performance analysis and comparison,” Intern. Workshop on Convergent Tech. (IWCT). 05, Oulu, Finland, 6-10 Jun. 2005

Here, the formula 5 is likelihood when a channel gain is ideally estimated without regarding errors, that is, when a probability model for signal detection is able to be represented by using data with noise having an ideal Gaussian distribution. On the other hand, when a channel estimation value is used, noise is added also to the channel estimation value as well as to a data signal. Therefore, noise included in a data signal that is obtained as a result of channel compensation of the data signal by using the channel estimation value does not always have an ideal Gaussian distribution. Accordingly, there is a problem that the bit LLR calculated by using the formula 5 includes error caused by data with noise that does not conform to a Gaussian distribution.

The invention has been made in view of such circumstances and provides a reception device and a reception method capable of suppressing error included in a bit LLR obtained by demodulation using a channel estimation value.

### SUMMARY OF THE INVENTION

(1) The invention has been made in order to solve the aforementioned problem, and one aspect of the invention is a reception device including: a reception unit for receiving a signal representing a bit sequence; a channel estimation unit for estimating channel variation that the signal undergoes and calculating a channel estimation value representing the channel variation; and a demodulation unit for demodulating the signal by using the channel estimation value and restoring each bit included in the bit sequence, in which the demodulation unit performs demodulation of the signal by using a value indicating magnitude of error (MSE: Mean Square Error) included in the channel estimation value.

(2) Another aspect of the invention is the reception device according to (1), in which the demodulation unit may perform the demodulation by using a probability density function that is a probability density function of the signal and that is a product of two probability density functions each represents a corresponding independent Gaussian variable by using at least the signal and the value indicating the magnitude of the error.

(3) Another aspect of the invention is the reception device according to (1) or (2), which may include a decoding unit for performing error correction decoding for the bit restored by the demodulation unit by using a state transition probability according to reception power of the signal.

(4) Another aspect of the invention is the reception device according to any one of (1) to (3), which may include a decoding unit for performing error correction decoding for the bit restored by the demodulation unit; and a replica generation unit for generating a replica of a transmission symbol by using the bit subjected to the error correction decoding, and in which channel estimation by the channel estimation unit, demodulation by the demodulation unit, error correction decoding by the decoding unit and generation of the replica by the replica generation unit may be performed iteratively, and the channel estimation unit may perform channel estimation by using the replica generated by the replica generation in second and subsequent times of the iteration.

(5) Another aspect of the invention is the reception device according to any one of (1) to (4), in which the channel estimation unit calculates, for each reception symbol included in the received signal, a channel estimation value used for demodulating the reception symbol, and a channel estimation value used for demodulating a first reception symbol is a value obtained by performing channel estimation without using a replica of a transmission symbol of the first reception symbol.

(6) Another aspect of the invention is a reception method, including: a first step of receiving a signal representing a bit sequence; a second step of estimating channel variation that the signal undergoes and calculating a channel estimation value representing the channel variation; and a third step of demodulating the signal by using the channel estimation value and restoring each bit included in the bit sequence, in which demodulation of the signal is performed by using a value indicating magnitude of error included in the channel estimation value at the third step.

According to one aspect of the invention, it is possible to suppress error included in a bit LLR obtained by demodulation using a channel estimation value.

### BRIEF DESCRIPTION OF THE DRAWINGS

FIG. 1 is a schematic block diagram showing an example of a configuration of a communication system in a first embodiment of the invention.

FIG. 2 is a schematic block diagram showing an example of a configuration of a transmitter of a base station device 101 in the embodiment.

FIG. 3 is a view showing an example of a frame composition of signals transmitted by the base station device 101 in the embodiment.

FIG. 4 is a schematic block diagram showing an example of a configuration of a receiver of a terminal device 102 in the embodiment.

FIG. 5 is a schematic block diagram showing a configuration of a demodulation unit 407 (here, β=1) in the embodiment.

FIG. 6 is a view showing results of simulation of the embodiment.

FIG. 7 is a view showing results of simulation of a modified example 1 of the embodiment.

FIG. 8 is a schematic block diagram showing an example of a configuration of a receiver of a terminal device 102a in a second embodiment of the invention.

### DETAILED DESCRIPTION OF THE INVENTION

### First Embodiment

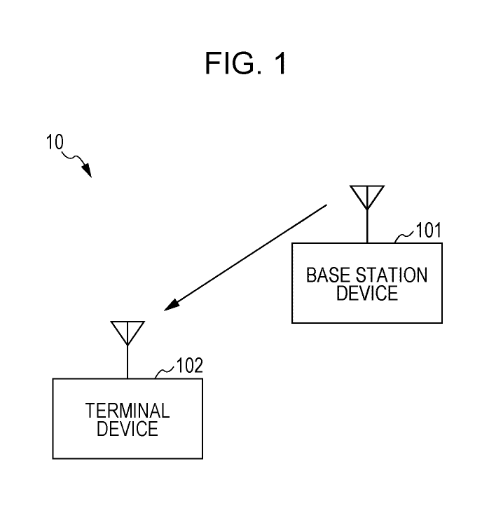

A first embodiment of the invention will hereinafter be described with reference to drawings. FIG. 1 is a schematic block diagram showing an example of a configuration of a communication system in the present embodiment. A communication system 10 in the present embodiment is constituted by including a base station device 101 and a terminal device 102. The communication system 10 is a system in which the base station device 101 transmits data to the terminal device 102. Though one terminal device 102 is illustrated in FIG. 1, two or more terminal devices 102 may exist. Moreover, the present embodiment and embodiments below are intended for downlink (transmission from the base station device 101 to the terminal device 102), but are also applicable to uplink (data transmission from the terminal device to the base station device).

Further, though OFDM (Orthogonal Frequency Division Multiplexing) is assumed as a communication method, applying to any communication methods, such as narrow-band single carrier transmission, SC-FDMA (Single Carrier Frequency Division Multiple Access, also referred to as DFT-S-OFDM (Discrete Fourier Transform Spread OFDM)), DS-CDMA (Direct Sequence Code Division Multiple Access) or MC-CDMA (Multi-Carrier CDMA), is possible regardless of cable communication or radio communication. In the case of applying, processing disclosed in the present embodiment may be applied for each subcarrier or for each symbol after equalization. Moreover, data to be transmitted may be not only an information bit sequence but control information.

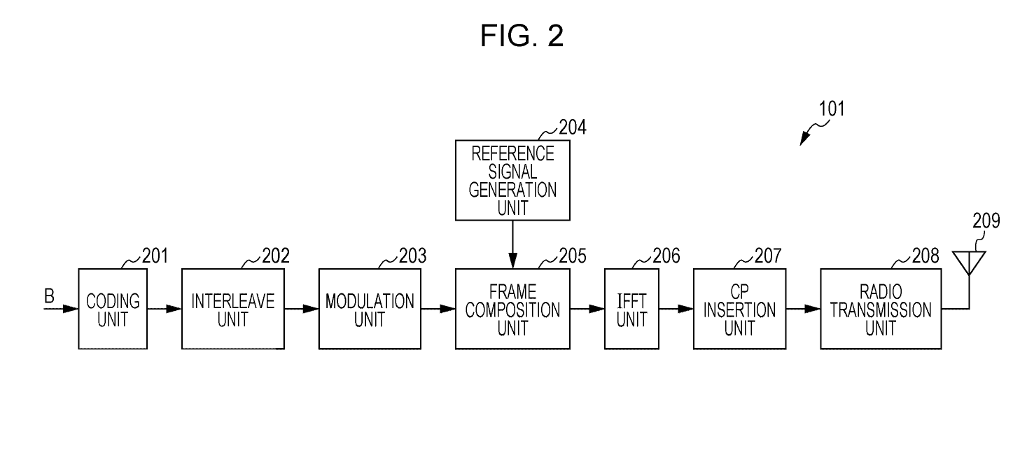

FIG. 2 is a schematic block diagram showing an example of a configuration of a transmitter of the base station device 101 in the present embodiment. The base station device 101 is constituted by including a coding unit 201, an interleave unit 202, a modulation unit 203, a reference signal generation unit 204, a frame composition unit 205, an IFFT (Inverse Fast Fourier Transform) unit 206, a CP (Cyclic Prefix) insertion unit 207, a radio transmission unit 208, and a transmit antenna 209. Note that, in addition to each of the units, the base station device 101 is constituted by including a configuration that a base station device generally has, such as a reception unit that receives a radio signal from the terminal device 102, but illustration and description thereof will be omitted here.

Moreover, the base station device 101 includes one transmit antenna in FIG. 2, but may have two or more and use a publicly known MIMO technique such as spatial multiplex or transmit antenna diversity. Note that, the number of transmit antennas may be considered as the number of antenna ports, and since the number of antenna ports is defined as the number of transmit antennas capable of transmitting different transmission signals, when a same signal is transmitted by, for example, three transmit antennas, the number of antenna ports is defined as one.

The coding unit 201 applies error correction coding such as turbo code or convolutional code to an information bit sequence B which is input. A coded bit sequence which is coded by the coding unit 201 is input to the interleave unit 202. The interleave unit 202 performs processing of sorting the coded bit sequence, which is input, in a predetermined order stored in the interleave unit 202. Coded bits sorted by the interleave unit 202 are input to the modulation unit 203. The modulation unit 203 converts the coded bit sequence which is input from the interleave unit 202 into a modulation symbol by BPSK (Binary Phase Shift Keying). The obtained modulation symbol is input to the frame composition unit 205.

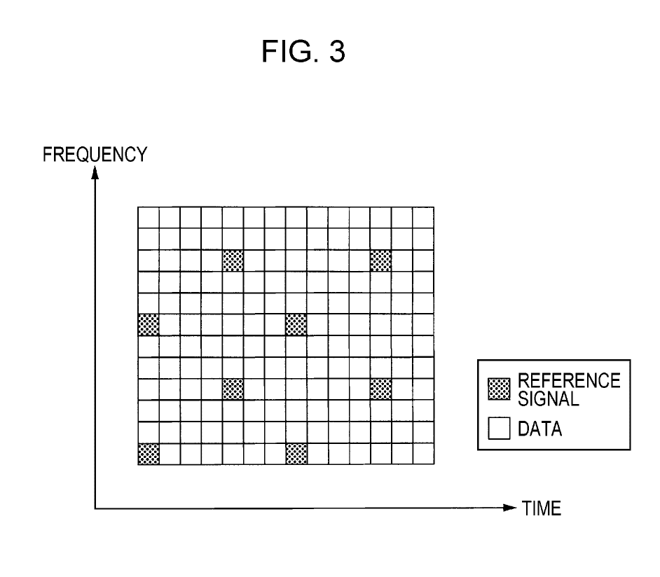

The reference signal generation unit 204 generates a reference signal, which is a known signal in the terminal device 102, to input to the frame composition unit 205. The frame composition unit 205 composes a transmission frame by using the reference signal input from the reference signal generation unit 204 and the modulation symbol input from the modulation unit 203. FIG. 3 is a view showing an example of a frame composition of signals transmitted by the base station device 101. The frame composition is essentially a frame composition used for uplink of LTE (Long Term Evolution), but is used to simplify description. FIG. 3 represents a subframe when one RB (Resource Block) is used, and one RB is formed by one hundred and sixty-eight REs (Resource Elements) in total of twelve subcarriers and fourteen OFDM symbols.

Though description will be given below for a case where one frame is composed of two slots and channel estimation is performed in each of the slots, the invention is not limited thereto and may perform channel estimation for each frame and is applicable also to a frame composition other than that of FIG. 3. Here, the resource element is a minimum unit of a resource capable of being used in a frequency direction and a time direction.

The frame composition unit 205 arranges the reference signal input from the reference signal generation unit 204 in a black resource element of FIG. 3 and arranges the data signal input from the modulation unit 203 in a white resource element to compose a transmission frame. Though only one RB is shown in FIG. 3, the number of RBs is not limited to one and may be plural.

With reference back to FIG. 2, the transmission frame composed by the frame composition unit 205 is input to the IFFT unit 206 for each of one OFDM symbol. The IFFT unit 206 applies IFFT of N_{FFT} points to each of OFDM symbols input from the frame composition unit 205 to thereby perform transformation from a frequency domain signal into a time domain signal. At this time, zero is input to a subcarrier in which neither the reference signal nor the data signal is arranged. The signal transformed from the frequency domain signal into the time domain signal by the IFFT at the IFFT unit 206 is input to the CP insertion unit 207. By copying backward N_{CP} points of the time domain signal of N_{FFT} points to insert to a head, the CP insertion unit 207 generates the time domain signal of (N_{FFT}+N_{CP}) points. The CP insertion unit 207 inputs the generated time domain signal to the radio transmission unit 210. The radio transmission unit 208 applies D/A (Digital-to-Analog) conversion, band restriction filtering, up-conversion and the like to the input signal. An output of the radio transmission unit 208 is transmitted to the terminal device 102 through the transmit antenna 209.

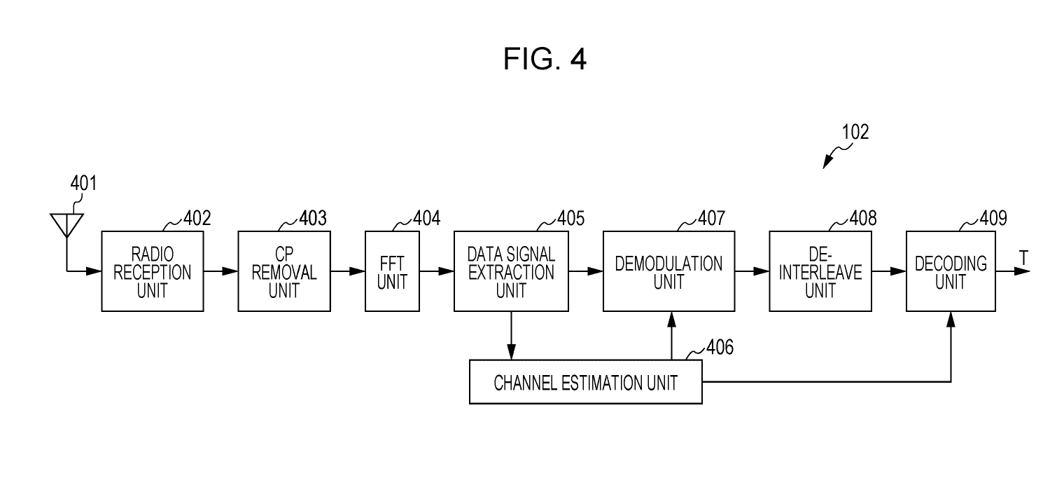

FIG. 4 is a schematic block diagram showing an example of a configuration of a receiver of the terminal device 102 in the present embodiment. The terminal device 102 is constituted by including a receive antenna 401, a radio reception unit 402, a CP removal unit 403, an FFT (Fast Fourier Transform) unit 404, a data signal extraction unit 405, a channel estimation unit 406, a demodulation unit 407, a de-interleave unit 408, and a decoding unit 409. Note that, in addition to each of the units, the terminal device 102 is constituted by including a configuration that a terminal device performing radio communication with a base station device generally has, such as a transmission unit that transmits a radio signal to the base station device 101, but illustration and description thereof will be omitted here.

The receive antenna 401 receives a signal transmitted from the base station device 101. The terminal device 102 has one receive antenna in the present embodiment, but may have a plurality of receive antennas and a publicly known technique such as spatial filtering or receive antenna diversity may be applied.

The signal received by the receive antenna 401 is input to the radio reception unit 402. The radio reception unit 402 applies processing, such as down-conversion, band restriction filtering and A/D (Analog-to-Digital) conversion, to the input signal.

A processing result by the radio reception unit 402 is input to the CP removal unit 403. The CP removal unit 403 partitions the received signal for each of (N_{FFT}+N_{CP}) points, and removes N_{CP} points from a head of the received signal of (N_{FFT}+N_{CP}) points. A signal for each of N_{FFT} points, which is a result of removal by the CP removal unit 403, is input to the FFT unit 404. The FFT unit 404 applies FFT (Fast Fourier Transform) of N_{FFT} points to the time domain signal for each of N_{FFT} points, which is input, to thereby perform transformation from the time domain signal into a frequency domain signal (received frequency domain signal).

Note that, the processing performed at the FFT unit 404 may not be necessarily FFT, and may be, for example, DFT (Discrete Fourier Transform). The received frequency domain signal which is a result of the transformation by the FFT unit 404 is input to the data signal extraction unit 405. The data signal extraction unit 405 demultiplexes a reference signal (received reference signal) from the received frequency domain signal to input to the channel estimation unit 406. The data signal extraction unit 405 further demultiplexes a data signal or a control signal from the received frequency domain signal to input to the demodulation unit 407. The data signal or the control signal, which is demultiplexed, is referred to as a received data signal below.

The channel estimation unit 406 uses the received reference signal, which is input, to perform estimation of channel variation (hereinafter, referred to as channel estimation) and estimation of average noise power (or a noise power spectral density, noise energy) for compensating for influence of fading (channel variation) applied to the data signal on a channel. Though a channel estimation method applied in the channel estimation unit 406 may be any one, description will be given in the present embodiment by exemplifying a case where channel estimation with an LS (Least Square) reference is used as the channel estimation method. When a received reference signal yₚ in a certain subcarrier is represented by a formula 6 by using a transmitted reference signal xₚ, a channel h, and noise nₚ when the reference signal is received, a channel estimation value h (hat) with the LS reference is represented by a formula 7.

$$\begin{matrix}[ Expression 6 ] & \\ {y}_{p} = {hx}_{p} + {n}_{p} & ( formula 6 ) \\ [ Expression 7 ] & \\ \hat{h} = \frac{{y}_{p}}{{x}_{p}} = h + {x}_{p}^{- 1} {n}_{p} & ( formula 7 )\end{matrix}$$

The channel estimation unit 406 is premised to apply channel estimation based on the formula 7 to a resource element in which the reference signal has been received (black part in FIG. 3) and perform zero-order interpolation, but may calculate a channel estimation value in a resource element in which data has been received (white part in FIG. 3) by interpolation such as first-order interpolation or MMSE (Minimum Mean Square Error) interpolation. The obtained channel estimation value is input to the demodulation unit 407. Further, in addition to the channel estimation value h (hat), an average noise power spectral density N₀ and a transmission power spectral density of a data signal E_{S} are input to the demodulation unit 407. For simplifying description, it is set that the transmission power spectral density of the data signal E_{S} and a transmission power spectral density of a pilot signal E_{P} are known in a receiver. However, a formula E_{S} (or E_{P}) which is finally used for computation is able to be developed to a formula by which multiplication by a square of a channel gain h (or channel estimation value h (hat)). A result of multiplying by the square of the channel gain h is the received power spectral density and is able to be observed also in the receiver, so that the present embodiment is applicable without difficulty even when a transmission power spectrum is not known. In this case, development of a formula is to be performed differently from those of the present embodiment and other embodiments, but a bit LLR is able to be calculated based on similar concept.

The demodulation unit 407 demodulates the received data signal, which is input from the data signal extraction unit 405, by using the corresponding channel estimation value input from the channel estimation unit 406. With the demodulation, the demodulation unit 407 restores coded bits represented by the received data signal to calculate the LLR of each of the bits. Note that, channel compensation for the received data signal and restoration of the bits represented by the received data signal are performed with the demodulation by the demodulation unit 407. When performing the demodulation, the demodulation unit 407 in the present embodiment suppresses error included in a bit sequence by using variance of the channel estimation value. Processing of the demodulation unit 407 will be described in detail below.

A bit sequence output by the demodulation unit 407 is input to the de-interleave unit 408. The de-interleave unit 408 applies processing of de-interleaving the interleave having been applied in the base station device 101 (de-interleaving processing) to the input bit sequence. The bit sequence subjected to the de-interleaving processing by the de-interleave unit 408 is input to the decoding unit 409.

The decoding unit 409 performs decoding for the bit sequence subjected to the de-interleaving processing based on error correction coding applied in the base station device 101, and outputs an obtained restored bit sequence T.

When performing the decoding, the decoding unit 409 uses an instantaneous received power spectral density |h|²E_{S} and the average noise power spectral density N₀, which are obtained from the channel estimation unit 406, and description thereof will be given in detail below.

Next, the processing of the demodulation unit 407 will be described in detail. When an ideal value is obtained by channel estimation by the channel estimation unit 406 without influence of noise or the like, the demodulation unit 407 may merely calculate the LLR based on the formula 5. However, since the channel estimation value h (hat) is calculated by the formula 7, an observable value z obtained by replacing the channel h in the formula 5 with a channel estimation value h (hat) is not matched with λₑ and has a value including error ε as shown in a formula 8. Here, in a right side of a first row of the formula 8, Eₛ is known, N₀ is calculated at the time of channel estimation, h (hat) is obtained by channel estimation, and y_{d} is a received signal. That is, the observable value z is a value which is able to be calculated by values thereof.

In the present embodiment, the demodulation unit 407 calculates a log likelihood ratio of the observable value z and inputs a sequence of the log likelihood ratio to the de-interleave unit 408 as a bit sequence. Note that, it is considered that error of estimation is included also in the average noise power spectral density N₀ in the formula 8, and it is set that the error is included in a channel estimation value.

$$\begin{matrix}[ Expression 8 ] & \\ \begin{matrix}z = \frac{4 \sqrt{{E}_{s}}}{{N}_{0}} Re [ {\hat{h}}^{*} {y}_{d} ] \\ = {λ}_{e} + ɛ\end{matrix} & ( formula 8 )\end{matrix}$$

For deriving a formula for calculating the log likelihood ratio of the observable value z, first, the formula 8 is modified like a following formula 9. In the formula 9, a and b are represented by a formula 10. Further, when γ and β in the formula 10 are set as a formula 11, a and b in the formula 9 serve as independent Gaussian variables.

$$\begin{matrix}[ Expression 9 ] & \\ z = \frac{4 \sqrt{{E}_{s}}}{{N}_{0}} Re [ {\hat{h}}^{*} {y}_{d} ] = \sqrt{β} ( {\vert a \vert}^{2} - {\vert b \vert}^{2} ) & ( formula 9 ) \\ [ Expression 10 ] & \\ \{ \begin{matrix}a = \sqrt{γ} ( h + \frac{{y}_{d}}{\sqrt{{E}_{s} β}} ) \\ b = \sqrt{γ} ( h - \frac{{y}_{d}}{\sqrt{{E}_{s} β}} )\end{matrix} & ( formula 10 ) \\ [ Expression 11 ] & \\ \{ \begin{matrix}γ = \frac{{E}_{s}}{{N}_{0}} \\ β = \frac{1}{{σ}_{est}^{2}} \frac{{N}_{0}}{{E}_{s}}\end{matrix} & ( formula 11 )\end{matrix}$$

In a formula 11, σₑₛₜ² is mean square error (MSE) of the actual channel h and the channel estimation value h (hat). That is, σₑₛₜ² is a value indicating a magnitude of the error of the channel estimation value h (hat). σₑₛₜ² depends on the channel estimation method, but, for example, in the case of LS channel estimation, is represented by a formula 12. Therefore, when the channel estimation method is the LS channel estimation, β is shown in a following formula 13. Note that, Eₚ is an average transmission power spectral density of a pilot signal.

$$\begin{matrix}[ Expression 12 ] & \\ {σ}_{est}^{2} = \frac{{N}_{0}}{{E}_{p}} & ( formula 12 ) \\ [ Expression 13 ] & \\ β = \frac{{E}_{p}}{{E}_{s}} & ( formula 13 )\end{matrix}$$

Further, since a and b are independent Gaussian variables, z is determined uniquely by absolute values of a and b, and thus a relation of a following formula 14 is satisfied.

$$\begin{matrix}[ Expression 14 ] & \\ \begin{matrix}p ( z \vert {x}_{d} ) = p ( \vert a \vert , \vert b \vert \vert {x}_{d} ) \\ = p ( \vert a \vert \vert {x}_{d} ) p ( \vert b \vert \vert {x}_{d} )\end{matrix} & ( formula 14 )\end{matrix}$$

Next, the LLR of z (λ_{Z}) is represented by a following formula 15 by using the formula 14.

$$\begin{matrix}[ Expression 15 ] & \\ \begin{matrix}{λ}_{z} = ln \frac{p ( z \vert {x}_{d} = + \sqrt{{E}_{s}} )}{p ( z \vert {x}_{d} = - \sqrt{{E}_{s}} )} \\ = ln \frac{( p \vert a \vert \vert {x}_{d} = + \sqrt{{E}_{s}} ) p ( \vert b \vert \vert {x}_{d} = + \sqrt{{E}_{s}} )}{( p \vert a \vert \vert {x}_{d} = - \sqrt{{E}_{s}} ) p ( \vert b \vert \vert {x}_{d} = - \sqrt{{E}_{s}} )}\end{matrix} & ( formula 15 )\end{matrix}$$

Here, an average value μₐ and variance Nₐ of a of the formula 10, and an average value μ_{b} and variance N_{b} of b are provided by a formula 16 and a formula 17, respectively.

$$\begin{matrix}[ Expression 16 ] & \\ \{ \begin{matrix}{μ}_{a} ( {x}_{d} ) = E [ a ] = \sqrt{γ} ( 1 + \frac{{x}_{d}}{\sqrt{{E}_{s} β}} ) h \\ {N}_{a} = V [ a ] = \frac{2}{β}\end{matrix} & ( formula 16 ) \\ [ Expression 17 ] & \\ \{ \begin{matrix}{μ}_{b} ( {x}_{d} ) = E [ b ] = \sqrt{γ} ( 1 - \frac{{x}_{d}}{\sqrt{{E}_{s} β}} ) h \\ {N}_{b} = V [ b ] = \frac{2}{β}\end{matrix} & ( formula 17 )\end{matrix}$$

Here, a and b have the same variance, Nₐ=N_{b}=N_{ab} is set. With the aforementioned average and variance, p(a|x_{d}) is provided by a following formula 18.

$$\begin{matrix}[ Expression 18 ] & \\ \begin{matrix}p ( a \vert {x}_{d} ) = \frac{1}{π {N}_{ab}} exp ( - \frac{{\vert a - {μ}_{a} ( {x}_{d} ) \vert}^{2}}{{N}_{ab}} ) \\ = p ( \vert a \vert , {θ}_{a} \vert {x}_{d} )\end{matrix} & ( formula 18 ) \\ [ Expression 19 ] & \\ \{ \begin{matrix}a = \vert a \vert ( cos {θ}_{a} + j sin {θ}_{a} ) \\ b = \vert b \vert ( cos {θ}_{b} + j sin {θ}_{b} ) \\ {μ}_{a} ( {x}_{d} ) = \vert {μ}_{a} ( {x}_{d} ) \vert ( cos {θ}_{{μ}_{a} ( {x}_{d} )} = {jsinθ}_{{μ}_{a} ( {x}_{d} )} ) \\ {μ}_{b} ( {x}_{d} ) = \vert {μ}_{b} ( {x}_{d} ) \vert ( cos {θ}_{{μ}_{b} ( {x}_{d} )} = {jsinθ}_{{μ}_{b} ( {x}_{d} )} ) \\ {θ}_{a} = {tan}^{- 1} \frac{Im [ a ]}{Re [ a ]} \\ {θ}_{b} = {tan}^{- 1} \frac{Im [ b ]}{Re [ b ]} \\ {θ}_{{μ}_{a} ( {x}_{d} )} = {tan}^{- 1} \frac{Im [ {μ}_{a} ( {x}_{d} ) ]}{Re [ {μ}_{a} ( {x}_{d} ) ]} \\ {θ}_{{μ}_{b} ( {x}_{d} )} = {tan}^{- 1} \frac{Im [ {μ}_{b} ( {x}_{d} ) ]}{Re [ {μ}_{b} ( {x}_{d} ) ]}\end{matrix} & ( formula 19 )\end{matrix}$$

Since the LLR of the formula 15 is represented only by the absolute value of a, by performing peripheral integration with respect to a phase in the formula 18, a formula 20 is obtained. In the formula 20, I₀(x) is a modified Bessel function of the first kind and zero order and is represented by a following formula.

$$\begin{matrix} [ Expression 20 ] & \\ \begin{matrix}p ( \vert a \vert \vert {x}_{d} ) = {\int }_{- π}^{π} p ( \vert a \vert , {θ}_{a} \vert {x}_{d} ) d {θ}_{a} \\ = \frac{2 \vert a \vert}{π {N}_{ab}} exp ( - \frac{{\vert a \vert}^{2} + {\vert {μ}_{a} ( {x}_{d} ) \vert}^{2}}{{N}_{ab}} ) {\int }_{- π}^{π} ( \frac{\vert a \vert \vert {μ}_{a} ( {x}_{d} ) \vert cos ( {θ}_{a} - {θ}_{{μ}_{a}} )}{{N}_{ab}} ) d {θ}_{a} \\ = \frac{2 \vert a \vert}{ {N}_{ab}} exp ( - \frac{{\vert a \vert}^{2} + {\vert {μ}_{a} ( {x}_{d} ) \vert}^{2}}{{N}_{ab}} ) {I}_{0} ( \frac{2 \vert a \vert {\vert {μ}_{a} ( {x}_{d} ) \vert}^{2}}{{N}_{ab}} )\end{matrix} & ( formula 20 ) \\ [ Expression 21 ] & \\ {I}_{0} ( x ) = \frac{1}{π} {\int }_{0}^{π} exp ( x cos θ ) d θ & ( formula 21 )\end{matrix}$$

By calculating b similarly, the formula 15 is able to be modified like a following formula 22.

$$\begin{matrix}[ Expression 22 ] & \\ \begin{matrix}{λ}_{z} = \frac{p ( z \vert {x}_{d} = + \sqrt{{E}_{s}} )}{p ( z \vert {x}_{d} = - \sqrt{{E}_{s}} )} \\ = ln \frac{{I}_{0} ( \frac{2 \vert a \vert \vert {μ}_{a} ( + \sqrt{{E}_{s}} ) \vert}{{N}_{ab}} ) {I}_{0} ( \frac{2 \vert b \vert \vert {μ}_{b} ( + \sqrt{{E}_{s}} ) \vert}{{N}_{ab}} )}{{I}_{0} ( \frac{2 \vert a \vert \vert {μ}_{a} ( - \sqrt{{E}_{s}} ) \vert}{{N}_{ab}} ) {I}_{0} ( \frac{2 \vert b \vert \vert {μ}_{b} ( - \sqrt{{E}_{s}} ) \vert}{{N}_{ab}} )}\end{matrix} & ( formula 22 )\end{matrix}$$

In the case of β=1, that is, when the noise power spectral density included in the received data signal and MSE (mean square error) of the channel estimation value are equal (when the data signal and the reference signal have equal average transmission power in the LS channel estimation), the formula 22 becomes a following formula 23.

$$\begin{matrix}[ Expression 23 ] & \\ {λ}_{z} = ln \frac{{I}_{0} ( 2 \sqrt{γ} \vert a \vert \vert h \vert )}{{I}_{0} ( 2 \sqrt{γ} \vert b \vert \vert h \vert )} & ( formula 23 )\end{matrix}$$

Here, an approximation formula of a following formula 24 is able to be used for the modified Bessel function of the first kind and zero order I₀.

Alternatively, approximation of a following formula 25 is also able to be used.

$$\begin{matrix}[ Expression 24 ] & \\ {I}_{0} ( x ) = \frac{1}{\sqrt{2 π x}} exp ( x ) , x >> 1 & ( formula 24 ) \\ [ Expression 25 ] & \\ \begin{matrix}{λ}_{z} = ln \frac{{I}_{0} ( 2 \sqrt{γ} \vert a \vert \vert h \vert )}{{I}_{0} ( 2 \sqrt{γ} \vert b \vert \vert h \vert )} \\ \approx ln \vert b \vert - ln \vert a \vert + 2 \vert h \vert \sqrt{γ} ( \vert a \vert - \vert b \vert ) , ( 2 \vert h \vert \sqrt{γ} >> 0 )\end{matrix} & ( formula 25 )\end{matrix}$$

The demodulation unit 407 in the present embodiment performs demodulation processing by using the formula 22 described above. The modified Bessel function of the first kind and zero order shown in the formula 24 may not be subjected to approximation necessarily and may be calculated actually. Though a channel value h which is unknown is included in the formulas used by the demodulation unit 407, such as the formulas 22, 23 and 25, the demodulation unit 407 in the present embodiment performs computation by substituting the channel estimation value h (hat) into the channel value h. In all the formulas, only an absolute value of the channel value h is used and the phase is not affected, so that even when the channel estimation value h (hat) is substituted as the channel value h into the formulas, error to be caused is small and significant deterioration of property does not occur.

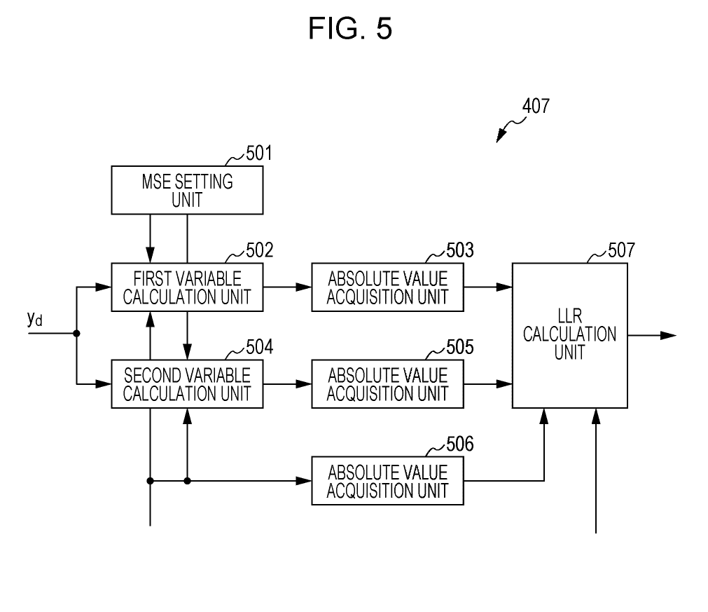

Next, description will be given by using a drawing for processing performed by the demodulation unit 407 in the case of β=1, that is, for a case where the formula 23 is used. Note that, in the case of β≠1, the LLR needs to be calculated not by the formula 23 but by the formula 22, so that the demodulation unit 407 has a different configuration from a configuration of FIG. 5, description of which will be omitted. FIG. 5 is a schematic block diagram showing an example of the configuration of the demodulation unit 407 in the case of β=1. The demodulation unit 407 is constituted by including an MSE setting unit 501, a first variable calculation unit 502, an absolute value acquisition unit 503, a second variable calculation unit 504, an absolute value acquisition unit 505, an absolute value acquisition unit 506, and an LLR calculation unit 507.

To the demodulation unit 407, the data signal y_{d} is input from the data signal extraction unit 405 as well as the channel estimation value h (hat) and the average noise power spectral density N₀ are input from the channel estimation unit 406. Among them, the data signal y_{d} is input to the first variable calculation unit 502 and the second variable calculation unit 504. The channel estimation value h (hat) is input to the first variable calculation unit 502, the second variable calculation unit 504, and the absolute value acquisition unit 506. Though not shown, the average noise power spectral density is input to the first variable calculation unit 502, the second variable calculation unit 504 and the LLR calculation unit 507.

The first variable calculation unit 502 calculates a value of a based on the formula 10. The second variable calculation unit 504 calculates a value of b based on the formula 10 similarly. The values of a and b, which are calculated by the first variable calculation unit 502 and the second variable calculation unit 504, are respectively input to the absolute value acquisition units 503 and 504. The absolute value acquisition units 503 and 505 apply, to the values of a and b represented by complex numbers, processing for acquiring absolute values thereof. The calculated absolute values are input to the LLR calculation unit 507.

On the other hand, the channel estimation value h (hat) output from the channel estimation unit 406 is also input to the absolute value acquisition unit 506. In the same manner, the absolute value acquisition unit 506 applies processing for acquiring an absolute value also to the channel estimation value h (hat) which is input. The absolute value of the channel estimation value, which is calculated here, is input to the LLR calculation unit 507.

The LLR calculation unit 507 calculates the LLR by using the absolute values input from the absolute value acquisition units 503, 505 and 506, the average noise power spectral density input from the channel estimation unit 406, and the formula 23, and inputs the obtained LLR to the de-interleave unit 408. Note that, the modified Bessel function of the first kind and zero order is able to be calculated by using approximation of the formula 24, the formula 25 and the like.

Meanwhile, when the channel estimation value is obtained ideally, the LLR conforms to a Gaussian distribution and a ratio of an average value and variance of the LLR becomes one to two. Satisfying the ratio is called satisfying a consistency condition. On the other hand, when an LLR calculation method of the present embodiment is used, the LLR conforms to a Gaussian distribution but does not satisfy the consistency condition.

In a decoder such as a turbo decoder, a state transition probability is generally calculated by utilizing that the ratio of the average value and the variance becomes one to two under the consistency condition, while, in the LLR calculation method of the present embodiment, the consistency condition is not satisfied and the ratio of the average and the variance becomes different depending on received power. Thus, the decoding unit 409 in the present embodiment generates and holds a table of the ratio of the average value and the variance at each instantaneous SNR (Signal to Noise power Ratio) in the decoding unit 409, and refers to the ratio of the average and the variance according to the instantaneous received SNR calculated by the channel estimation unit 406 to reflect on the state transition probability.

Note that, the ratio of the average value and the variance at each SNR, which is calculated in advance by simulation or the like, is stored. Thereby, the decoding processing is able to be performed with a more appropriate state transition probability compared to calculation with the ratio of the average value and the variance as one to two at all times. However, decoding processing which is similar to conventional one may be performed by performing approximation to one to two at all times.

In this manner, in the present embodiment, by using the LLR calculation method using σₑₛₜ² indicating magnitude of error included in the channel estimation value, it is possible to suppress the error at the time of channel estimation by calculating the LLR with the approximation which is to conform to a Gaussian distribution avoided even though there are two pieces of noise at the time of calculating the LLR. By performing error decision and error correction decoding by using the LLR, it is possible to improve a bit error rate compared to a case where a conventional LLR calculation method is used.

### Modified Example 1

Though description has been given in the aforementioned embodiment for a case where the BPSK is used as a modulation method, a case where QPSK is used will be described below as a modified example. That is, description will be given for processing performed by the demodulation unit 407 of the terminal device 102 when the modulation unit 203 of the base station device 101 converts a coded bit sequence into a modulation symbol by QPSK.

When the modulation method is the QPSK, two bits forming a QPSK symbol are set as c₀ and c₁, respectively. In this case, χ_{d}ε{χ₀, χ₁, χ₂, χ₃} is represented by a following formula 26.

Note that, gray mapping is used for association of the QPSK symbol with a bit value.

[Expression 26]

x_{d}=\sqrt{Eₛ/2}{(2c₀−1)+j(2c₁−1)} (formula 26)

That is, in the case of {c₀, c₁}={0, 0}, a modulation point is χ₀, in the case of {c₀, c₁}={0, 1}, the modulation point is χ₀, in the case of {c₀, c₁}={1, 0}, the modulation point is χ₀, and in the case of {c₀, c₁}={1, 1}, the modulation point is χ₀.

First, a formula of calculating the LLR of the bit c₀ using the channel estimation value h hat is derived based on a following formula 27.

$$\begin{matrix}[ Expression 27 ] & \\ \begin{matrix}{z}_{0} = ln \frac{p ( {y}_{d} \vert {c}_{0} = 1 )}{p ( {y}_{d} \vert {c}_{0} = 0 )} \\ = \frac{2 \sqrt{2 {E}_{s}}}{{N}_{0}} Re [ {\hat{h}}^{*} {y}_{d} ] \\ = \sqrt{β} ( {\vert a \vert}^{2} - {\vert b \vert}^{2} )\end{matrix} & ( formula 27 )\end{matrix}$$

Here, a and b are independent Gaussian variables and are represented by a formula 28. Each of an average value μₐ and variance Nₐ of a is provided by a formula 29, and each of an average value μ_{b} and variance N_{b} of b is provided by a formula 30.

$$\begin{matrix}[ Expression 28 ] & \\ \{ \begin{matrix}a = {2}^{- \frac{1}{4}} \sqrt{γ} ( \hat{h} + \frac{{y}_{d}}{\sqrt{{E}_{s} β}} ) \\ b = {2}^{- \frac{1}{4}} \sqrt{γ} ( \hat{h} - \frac{{y}_{d}}{\sqrt{{E}_{s} β}} )\end{matrix} & ( formula 28 ) \\ [ Expression 29 ] & \\ \{ \begin{matrix}{μ}_{a} ( {x}_{d} ) = E [ a ] = {2}^{- \frac{1}{4}} \sqrt{γ} ( 1 + \frac{{x}_{d}}{\sqrt{{E}_{s} β}} ) h \\ {N}_{a} = V [ a ] = \frac{\sqrt{2}}{β}\end{matrix} & ( formula 29 ) \\ [ Expression 30 ] & \\ \{ \begin{matrix}{μ}_{b} ( {x}_{d} ) = E [ b ] = {2}^{- \frac{1}{4}} \sqrt{γ} ( 1 - \frac{{x}_{d}}{\sqrt{{E}_{s} β}} ) h \\ {N}_{b} = V [ b ] = \frac{\sqrt{2}}{β}\end{matrix} & ( formula 30 )\end{matrix}$$

Here, a and b have the same variance, so that Nₐ=N_{b}=N_{ab} is provided. When similar calculation to that of the formula 22 is performed with the aforementioned average and variance, the modulation points with c₀=0 are χ₀ and χ₁ and the modulation points with c₀=1 are χ₂ and χ₃, so that a following formula 31 is obtained. The demodulation unit 407 uses the formula 31 as the formula of calculating the LLR of the bit c₀.

$$\begin{matrix}[ Expression 31 ] & \\ \begin{matrix}{λ}_{z , 0} = ln \frac{\begin{matrix}{I}_{0} ( \frac{2 \vert a \vert \vert {μ}_{a} ( {χ}_{2} ) \vert}{{N}_{ab}} ) {I}_{0} ( \frac{2 \vert b \vert \vert {μ}_{a} ( {χ}_{2} ) \vert}{{N}_{ab}} ) + \\ {I}_{0} ( \frac{2 \vert a \vert \vert {μ}_{a} ( {χ}_{3} ) \vert}{{N}_{ab}} ) {I}_{0} ( \frac{2 \vert b \vert \vert {μ}_{a} ( {χ}_{3} ) \vert}{{N}_{ab}} )\end{matrix}}{\begin{matrix}{I}_{0} ( \frac{2 \vert a \vert \vert {μ}_{a} ( {χ}_{0} ) \vert}{{N}_{ab}} ) {I}_{0} ( \frac{2 \vert b \vert \vert {μ}_{a} ( {χ}_{0} ) \vert}{{N}_{ab}} ) + \\ {I}_{0} ( \frac{2 \vert a \vert \vert {μ}_{a} ( {χ}_{1} ) \vert}{{N}_{ab}} ) {I}_{0} ( \frac{2 \vert b \vert \vert {μ}_{a} ( {χ}_{1} ) \vert}{{N}_{ab}} )\end{matrix}} \\ = ln \frac{{I}_{0} ( \frac{2 \vert a \vert \vert {μ}_{a} ( {χ}_{2} ) \vert}{{N}_{ab}} ) {I}_{0} ( \frac{2 \vert b \vert \vert {μ}_{a} ( {χ}_{2} ) \vert}{{N}_{ab}} )}{{I}_{0} ( \frac{2 \vert a \vert \vert {μ}_{a} ( {χ}_{0} \vert}{{N}_{ab}} ) {I}_{0} ( \frac{2 \vert b \vert \vert {μ}_{a} ( {χ}_{0} ) \vert}{{N}_{ab}} )}\end{matrix} & ( formula 31 )\end{matrix}$$

Description has been given above for the bit c₀, and the bit c₁ will be then described. In the demodulation unit 407, the LLR of the bit c₁ is provided based on a following formula 32.

$$\begin{matrix}[ Expression 32 ] & \\ \begin{matrix}{z}_{1} = ln \frac{p ( {y}_{d} \vert {c}_{1} = 1 )}{p ( {y}_{d} \vert {c}_{1} = 0 )} \\ = \frac{2 \sqrt{2 {E}_{s}}}{{N}_{0}} Im [ {\hat{h}}^{*} {y}_{d} ] \\ = \sqrt{β} ( {\vert a \vert}^{2} - {\vert b \vert}^{2} )\end{matrix} & ( formula 32 )\end{matrix}$$

Here, a and b are independent Gaussian variables and are represented by a formula 33. Each of an average value μₐ and variance Nₐ of a is provided by a formula 34, and since the modulation points with c₁=0 are χ₀ and χ₂ and the modulation points with c₁=1 are χ₁ and χ₃, each of an average value μ_{b} and variance N_{b} of b is provided by a formula 35. Note that, j in the formula 33, the formula 34 and the formula 35 is an imaginary unit.

$$\begin{matrix}[ Expression 33 ] & \\ \{ \begin{matrix}a = {2}^{- \frac{1}{4}} \sqrt{γ} ( \hat{h} - j \frac{{y}_{d}}{\sqrt{{E}_{s} β}} ) \\ b = {2}^{- \frac{1}{4}} \sqrt{γ} ( \hat{h} - j \frac{{y}_{d}}{\sqrt{{E}_{s} β}} )\end{matrix} & ( formula 33 ) \\ [ Expression 34 ] & \\ \{ \begin{matrix}{μ}_{a} ( {x}_{d} ) = E [ a ] = {2}^{- \frac{1}{4}} \sqrt{γ} ( 1 - j \frac{{x}_{d}}{\sqrt{{E}_{s} β}} ) h \\ {N}_{a} = V [ a ] = \frac{\sqrt{2}}{β}\end{matrix} & ( formula 34 ) \\ [ Expression 35 ] & \\ \{ \begin{matrix}{μ}_{b} ( {x}_{d} ) = E [ b ] = {2}^{- \frac{1}{4}} \sqrt{γ} ( 1 + j \frac{{x}_{d}}{\sqrt{{E}_{s} β}} ) h \\ {N}_{b} = V [ b ] = \frac{\sqrt{2}}{β}\end{matrix} & ( formula 35 )\end{matrix}$$

Here, a and b have the same variance, so that Nₐ=N_{b}=N_{ab} is provided. When similar calculation to that of the formula 22 is performed with the aforementioned average and variance, a following formula 36 is obtained. The demodulation unit 407 uses the formula 36 as the formula of calculating the LLR of the bit c₁.

$$\begin{matrix}[ Expression 36 ] & \\ \begin{matrix}{λ}_{z , 1} = ln \frac{\begin{matrix}{I}_{0} ( \frac{2 \vert a \vert \vert {μ}_{a} ( {χ}_{1} ) \vert}{{N}_{ab}} ) {I}_{0} ( \frac{2 \vert b \vert \vert {μ}_{a} ( {χ}_{1} ) \vert}{{N}_{ab}} ) + \\ {I}_{0} ( \frac{2 \vert a \vert \vert {μ}_{a} ( {χ}_{3} ) \vert}{{N}_{ab}} ) {I}_{0} ( \frac{2 \vert b \vert \vert {μ}_{a} ( {χ}_{3} ) \vert}{{N}_{ab}} )\end{matrix}}{\begin{matrix}{I}_{0} ( \frac{2 \vert a \vert \vert {μ}_{a} ( {χ}_{0} ) \vert}{{N}_{ab}} ) {I}_{0} ( \frac{2 \vert b \vert \vert {μ}_{a} ( {χ}_{0} ) \vert}{{N}_{ab}} ) + \\ {I}_{0} ( \frac{2 \vert a \vert \vert {μ}_{a} ( {χ}_{2} ) \vert}{{N}_{ab}} ) {I}_{0} ( \frac{2 \vert b \vert \vert {μ}_{a} ( {χ}_{2} ) \vert}{{N}_{ab}} )\end{matrix}} \\ = ln \frac{{I}_{0} ( \frac{2 \vert a \vert \vert {μ}_{a} ( {χ}_{1} ) \vert}{{N}_{ab}} ) {I}_{0} ( \frac{2 \vert b \vert \vert {μ}_{a} ( {χ}_{1} ) \vert}{{N}_{ab}} )}{{I}_{0} ( \frac{2 \vert a \vert \vert {μ}_{a} ( {χ}_{0} \vert}{{N}_{ab}} ) {I}_{0} ( \frac{2 \vert b \vert \vert {μ}_{a} ( {χ}_{0} ) \vert}{{N}_{ab}} )}\end{matrix} & ( formula 36 )\end{matrix}$$

In this manner, the modulation unit 407 is able to calculate the LLR of each of the bits (c₀ and c₁) of the QPSK with the formula 31 and the formula 36. The similar is applicable also to a case where other modulation methods such as 16QPSK and 16QAM (Quadrature Amplitude Modulation) are used.

### Modified Example 2

Description has been given in the aforementioned embodiment and the modified example 1 thereof for a case where the channel estimation unit 406 uses the LS channel estimation as the channel estimation method. However, a new LLR calculation method using a channel estimation value is used in the present embodiment and the modified example thereof, but the channel estimation method may be any one without limitation to the LS channel estimation. Thus, as another channel estimation method, an LLR calculation method when channel estimation with a noise eliminated (NE) reference, which has been conventionally and commonly used as the channel estimation method, will be described.

First, the channel estimation with the NE reference performed by the channel estimation unit 406 will be described. When a complex channel gain of a channel is H(k) similarly to the formula 1, for example, in OFDM transmission, a channel vector H is represented by a formula 37. A vector of an LS channel estimation value H_{LS} obtained by the LS channel estimation is represented by a formula 38. Time responses (impulse responses) h and h_{LS} of H and H_{LS} are represented by a formula 39. Here, F is a DFT matrix of N points.

$$\begin{matrix}[ Expression 37 ] & \\ H = [ \begin{matrix}H ( 0 ) & H ( 1 ) & … & {H ( K - 1 ) ]}^{T}\end{matrix} & ( formula 37 ) \\ [ Expression 38 ] & \\ {\hat{H}}_{LS} = [ \begin{matrix}{\hat{H}}_{LS} ( 0 ) & {\hat{H}}_{LS} ( 1 ) & … & {{\hat{H}}_{LS} ( K - 1 ) ]}^{T}\end{matrix} & ( formula 38 ) \\ [ Expression 39 ] & \\ \{ \begin{matrix}h = \frac{1}{K} {F}^{H} H \\ {h}_{LS} = \frac{1}{K} {F}^{H} {\hat{H}}_{LS}\end{matrix} & ( formula 39 )\end{matrix}$$

In the channel estimation with the NE reference, by performing filtering of a following formula for the impulse responses obtained by the LS channel estimation, an impulse response vector h_{NE} from which noise has been eliminated is obtained.

[Expression 40]

ĥ_{NE}=Wĥ_{LS} (formula 40)

Here, a filter W is a matrix of K×K in which diagonal elements from 1 to L are 1 and other elements are 0. L is desirably the number of channel paths, but when the number of paths is not able to be estimated, is set as a given length such as CP (or guard interval). Further, the element does not need to be 1, and, for example, when there is a guard band, it is also possible to perform weighting in consideration of the guard band. By converting the obtained impulse response vector h_{NE} from which noise is eliminated into a frequency domain, a channel estimation vector H_{NE} from which noise is eliminated is obtained.

$$\begin{matrix}[ Expression 41 ] & \\ \begin{matrix}{\hat{H}}_{NE} = F {\hat{h}}_{NE} \\ = {FWF}^{H} {\hat{h}}_{LS} \\ = {[ \begin{matrix}{\hat{H}}_{NE} ( 0 ) & {\hat{H}}_{NE} ( 1 ) & … & {\hat{H}}_{NE} ( K - 1 )\end{matrix} ]}^{T}\end{matrix} & ( formula 41 )\end{matrix}$$

In the channel estimation with the NE reference, power of noise is able to be suppressed according to the number of elements of 1 included in the filter W. For example, when the number of elements of 1 is L and a size of the filter W is K×K as described above, the power of noise is able to be suppressed to L/K. Accordingly, MSE of the channel estimation with the NE reference is represented by a following formula 42. In this case, β is provided by a formula 43.

$$\begin{matrix}[ Expression 42 ] & \\ {σ}_{est}^{2} = \frac{L}{K} \frac{{N}_{0}}{{E}_{p}} & ( formula 42 ) \\ [ Expression 43 ] & \\ β = \frac{K}{L} \frac{{E}_{p}}{{E}_{s}} & ( formula 43 )\end{matrix}$$

By using the formula 43 instead of the formula 13 in the first embodiment and additionally using H_{NE}(k) (hat) instead of h (hat), the demodulation unit 407 is able to suppress error included in the bit LLR also when the channel estimation unit 406 uses the channel estimation with the NE reference. Though shown above is a case where the diagonal elements from 1 to L are 1 and other elements are 0 in the filter W, multiplication of a rectangle filter in a time domain is equivalent to convolutional computation of a sine function in a frequency domain. That is, the channel estimation with the NE reference may be called weighted averaging processing in the frequency domain. Improvement of accuracy of channel estimation by averaging may be performed also in an antenna direction when there is a correlation not only with a frequency, but with a time, a code or an antenna.

Even when a channel estimation method other than one with the LS reference or the NE reference is used, by theoretically calculating a value of mean square error MSE of the channel estimation value h (hat) or holding a value which is empirically obtained by simulation or the like to calculate β with the value, the LLR calculation method described above is applicable to cases where any channel estimation method is used. Note that, like the present embodiment and the modified example, β may be calculated without directly obtaining the mean square error MSE of the channel estimation value h (hat), but by substituting Eₛ, Eₚ, N₀ and the like into a formula obtained by substituting a formula of calculating the MSE into a definition formula of β, or a value of β according to a combination of values of Eₛ, Eₚ, N₀ and the like may be obtained in advance by simulation or the like and stored to use the value.

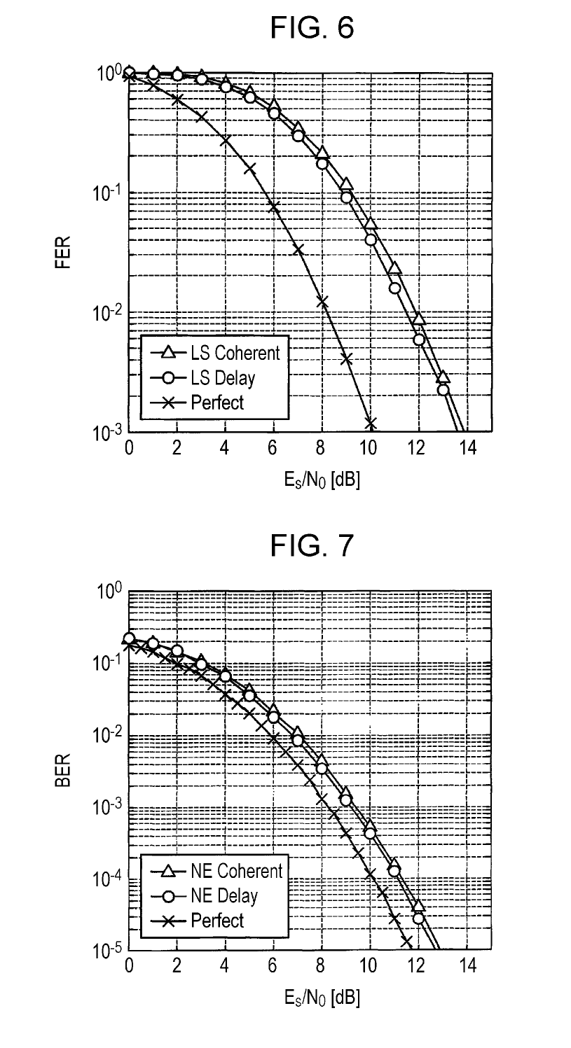

Results of simulation of a calculator with the LLR calculation method of the present embodiment are shown in FIG. 6 and FIG. 7.

FIG. 6 shows results of simulation when the channel estimation with the LS reference is used as the channel estimation, and FIG. 7 shows results of simulation when the channel estimation with the NE reference is used as the channel estimation. In FIG. 6, a horizontal axis indicates an average transmission power spectral density Eₛ/average noise spectral density N₀ (dB) and a vertical axis indicates a frame error rate (FER). As conditions of the simulation, it is set that subcarriers are 64, a CP length has 16 points, a modulation method is the QPSK, an error correction code is a turbo code with a coding rate of 1/2 and a constraint length of 4, a decoder is Max-Log-MAP decoding with a correction term having the iteration number of 8, and a channel model is Rayleigh fading having 12 paths with an attenuation constant of 2 dB. Further, a frame composition is set as not one of FIG. 3 but one in which one frame is composed of 1 pilot ODFM symbol and 16 data OFDM symbols. In FIG. 6 and FIG. 7, a plot with crosses (+) indicates a case where channel estimation is complete, triangles (▴) show performance when the conventional LLR calculation method is used, and circles (◯) show performance when the LLR calculation method of the present embodiment is used.

The LLR calculation method of the present embodiment has an improvement effect of 0.4 dB in FER=0.01 compared to the conventional one according to FIG. 6 in which the LS channel estimation is performed, and has an improvement effect of 0.15 dB according to FIG. 7 in which the NE channel estimation is performed. In this manner, it is possible to confirm that the LLR calculation method of the present embodiment has an effect of improvement in transmission performance.

### Second Embodiment

In the first embodiment, a case where data is demodulated by a channel estimation value obtained by a reference signal and further decoded has been described. Incidentally, decision-feedback channel estimation (iterative channel estimation) is effective that when reliability of data after decoding is high, a data signal is regarded as a reference signal and channel estimation is performed again. By applying the iterative channel estimation, the data signal is able to be handled as the reference signal. As a result thereof, the number of reference signals apparently increases and accuracy of the channel estimation is able to be improved significantly, which is a reason of being effective. Note that, though description will be given by exemplifying the case of applying to downlink of LTE, that is, OFDM transmission in the present embodiment as well, similarly to the first embodiment, applying to any communication systems is possible as long as being a system performing channel estimation.

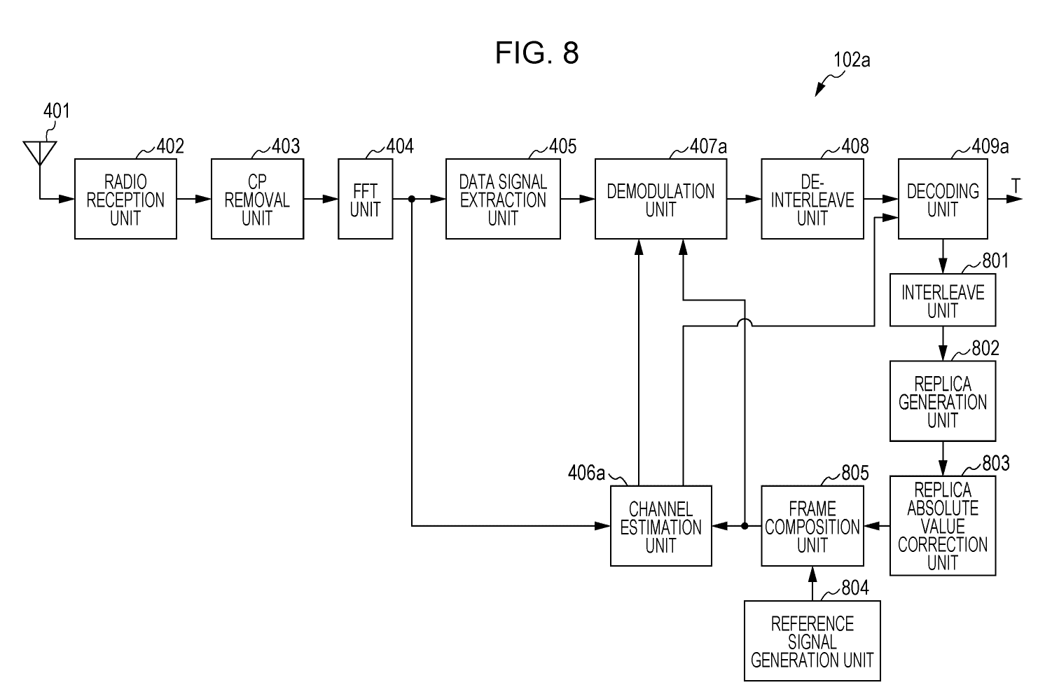

A base station device 101 in the present embodiment may have the same configuration as the configuration of the base station of the first embodiment, so that description thereof will be omitted. A signal transmitted by the base station device 101 is received by a terminal device 102a. FIG. 8 is a schematic block diagram showing an example of a configuration of a receiver of the terminal device 102a in the present embodiment. The terminal device 102a is constituted by including a receive antenna 401, a radio reception unit 402, a CP removal unit 403, an FFT (Fast Fourier Transform) unit 404, a data signal extraction unit 405, a channel estimation unit 406a, a demodulation unit 407a, a de-interleave unit 408, a decoding unit 409a, an interleave unit 801, a replica generation unit 802, a replica absolute value correction unit 803, a reference signal generation unit 804, and a frame composition unit 805. Note that, in addition to each of the units, the terminal device 102a is constituted by including a configuration that a terminal device which performs radio communication with a base station device generally has, such as a transmission unit that transmits a radio signal to the base station device 101, but illustration and description thereof will be omitted here.

A signal transmitted from the base station device 101 is received by the receive antenna 401 of the terminal device 102a. Note that, the terminal device 102a has one receive antenna in the present embodiment, but may have a plurality of receive antennas and a publicly known technique such as receive antenna diversity may be applied. The signal received by the receive antenna is input to the radio reception unit 402. The radio reception unit 402 applies down-conversion, band restriction filtering, A/D (Analog-to-Digital) conversion and the like to the input signal.

An output of the radio reception unit 402 is input to the CP removal unit 403. The CP removal unit 403 partitions the received signal for each of (N_{FFT}+N_{CP}) points, and removes N_{CP} points from a head of the received signal of (N_{FFT}+N_{CP}) points. A signal for each of N_{FFT} points, which is output by the CP removal unit 403, is input to the FFT unit 404. The FFT unit 404 applies FFT of N_{FFT} points to thereby perform transformation from a time domain signal for each of N_{FFT} points, which is input, into a frequency domain signal (received frequency domain signal). An output of the FFT unit 404 is input to the data signal extraction unit 405 and the channel estimation unit 406a.

The data signal extraction unit 405 extracts a received data signal from the received frequency domain signal in accordance with the frame composition of FIG. 3 to input to the demodulation unit 407a. The demodulation unit 407a uses a channel estimation value input from the channel estimation unit 406a to apply processing of compensating for an influence of a channel and transforming a symbol sequence after the channel compensation into a sequence of a bit LLR to the received data signal input from the data signal extraction unit 405. Channel compensation by using an average noise power spectral density input with the channel estimation value from the channel estimation unit 406a (for example, with an MMSE reference) may be performed. Processing performed by the demodulation unit 407a in the present embodiment will be described below in detail.

An LLR output by the demodulation unit 407a is input to the de-interleave unit 408, and subjected to processing of de-interleaving the interleave having been applied in the interleave unit 202 of the base station device 101. An output of the de-interleave unit 408 is input to the decoding unit 409a, and the decoding unit 409a performs decoding similarly to the decoding unit 409 in the first embodiment based on error correction coding applied at the base station device 101. A posteriori LLR of coded bits obtained by decoding processing is input to the interleave unit 801. The LLR input to the interleave unit 801 may be an external LLR. When the decoding unit 409a inputs the posteriori LLR of the coded bits to the interleave unit 801, the terminal device 102a performs iterative channel estimation, but when a condition of terminating iteration, such as when the predetermined iteration number is reached, is satisfied, the decoding unit 409a outputs a hard-decision result of decoding processing as a restored bit sequence T.

The interleave unit 801 applies sorting processing same as that of the interleave unit 202 of the base station device 101 to the LLR of the coded bits, which is input from the decoding unit 409a, and inputs the LLR of the coded bits after interleaving to the replica generation unit 802. The replica generation unit 802 generates a symbol replica (soft replica) of a transmission signal by the LLR of the coded bits, which is input, and a modulation method applied at the modulation unit 203 of the base station device 101 to input to the replica absolute value correction unit 803.

The replica absolute value correction unit 803 corrects an absolute value of the input symbol replica, and inputs the corrected symbol replica to the frame composition unit 805. For example, the replica absolute value correction unit 803 sets a size of the symbol replica as a given value (for example, 1) when, for example, an absolute value of the symbol replica is a predetermined value (threshold) or more, and sets the size of the symbol replica as 0 when the absolute value of the symbol replica is smaller than the predetermined value. The replica absolute value correction unit 803 corrects the size of the symbol replica, so that a symbol replica having low likelihood is not used for channel estimation. As a result thereof, it is possible to prevent deterioration of accuracy of the channel estimation.

Note that, the size of the symbol replica is set as 0 when the absolute value of the symbol replica is smaller than the predetermined value in the example above, but without setting as 0, a symbol replica whose absolute value is smaller than the predetermined value may be deleted and only a symbol replica whose absolute value is larger than the predetermined value may be input to the frame composition unit 805. Moreover, though described in the present embodiment is a case where one predetermined value is prepared to quantize the symbol replica to amplitude of binary of 0 and 1, a plurality of predetermined values may be prepared to perform processing of quantizing to amplitude of ternary or more, or the replica absolute value correction unit 803 may not correct the absolute value, that is, the soft replica may be also used as it is. The corrected symbol replica is input to the frame composition unit 805.

The reference signal generation unit 804 generates a reference signal same as that of the reference signal generation unit 204 of the base station device 101. The frame composition unit 805 composes a frame with a frame composition similar to that of the frame composition unit 205 of the base station device 101 (For example, FIG. 3) by using the reference signal input from the reference signal generation unit 804 and the replica input from the replica absolute value correction unit 803. The composed frame is input to the channel estimation unit 406a and the demodulation unit 407a. The channel estimation unit 406a performs channel estimation by using the received frequency domain signal input from the FFT unit 404. The channel estimation unit 406a performs channel estimation in the first time of iterative channel estimation by comparing a reference signal in the received frequency domain signal to the reference signal which is arranged in the frame input from the frame composition unit 805. However, in the second and subsequent times of the iterative channel estimation, the channel estimation unit 406a performs channel estimation by comparing the reference signal and a data signal in the received frequency domain signal to a replica of the reference signal and a data signal arranged in the frame input from the frame composition unit 805.

The channel estimation in the second and subsequent times of the iterative channel estimation will be described in detail. First, when the transmission frame composition as shown in FIG. 3 is assumed and a received signal in a k-th subcarrier of an m-th OFDM symbol is Y^{(m)}(k), a received signal sequence Y(k) in the k-th subcarrier is represented by a following formula 44.

[Expression 44]

Y(k)=[Y⁽¹⁾(k)Y⁽²⁾(k) . . . Y⁽¹⁴⁾(k)]^{T} (formula 44)

For example, in the case of k=3, Y⁽⁴⁾(3) and Y⁽¹¹⁾(3) are received reference signals and other elements serve as received data signals. The similar is applied also to other subcarriers, so that an index of k will be omitted and lowercase letters will be used below in order to simplify the description. Thus, the formula 44 is represented like a following formula 45.

[Expression 45]

y=[y⁽¹⁾y⁽²⁾ . . . y⁽¹⁴⁾]^{T} (formula 45)

The channel estimation unit 406a performs calculation with a following formula 46 to thereby calculate a channel estimation value h (hat) in each subcarrier. Here, x (hat) represents a replica of a transmission signal, and in an OFDM signal for transmitting a reference signal, the reference signal is input and a relational formula of a formula 47 is satisfied.

$$\begin{matrix}[ Expression 46 ] & \\ \hat{h} = {\hat{x}}^{+} y & ( formula 46 ) \\ [ Expression 47 ] & \\ \{ \begin{matrix}\hat{x} = [ \begin{matrix}{\hat{x}}^{( 1 )} & {\hat{x}}^{( 2 )} & … & {\hat{x}}^{( 7 )}\end{matrix} ] \\ {\hat{x}}^{+} = \frac{1}{{E}_{p} + \hat{M} {E}_{s}} [ \begin{matrix}{\hat{x}}^{{( 1 )}^{*}} & {\hat{x}}^{{( 2 )}^{*}} & … & {\hat{x}}^{{( 7 )}^{*}}\end{matrix} ]\end{matrix} & ( formula 47 )\end{matrix}$$

In the formula 47, M (hat) is the number of non-zero elements of a data symbol of x (hat) (maximum, 7). In this manner, the channel estimation unit 406a of the present embodiment performs channel estimation by using many received data signals when there are many replicas whose absolute value is large in the replicas input to the replica absolute value correction unit 803, thus making it possible to perform channel estimation with high accuracy. On the other hand, for example, when there is no replica whose absolute value is large, channel estimation is performed by using only a reference signal, so that deterioration in accuracy of channel estimation due to decision error of data is able to be suppressed.

Note that, since it is assumed that there is no time variation of a channel in the formula 46, all symbols are subjected to equal gain combining and one channel estimation value is calculated, but when there is time variation of a channel, a channel estimation value for each OFDM symbol may be calculated by performing not the equal gain combining but weighting combining. For example, any of averaging of only adjacent symbols, weighting with MSE being minimum, weighting with a sinc function or a Bessel function of the first kind and zero order may be used.

Further, the channel estimation unit 406a calculates average noise power in addition to the channel estimation value. A calculation method thereof may be any one. For example, in estimation of the average noise power, calculation may be performed by using reception power in a subcarrier in which none is transmitted (null-subcarrier), or calculation may be performed by, in a resource element in which a reference signal is received, subtracting a value obtained by multiplying the transmitted reference signal by a channel estimation value from the received signal. The channel estimation value and an average noise power spectral density, which are calculated by the channel estimation unit 406a, are input to the demodulation unit 407a and the decoding unit 409a.

Next, processing at the demodulation unit 407a, which is a characteristic of the present embodiment, will be described. Calculation of an LLR of the m-th OFDM symbol by using BPSK in the modulation unit 407a is performed based on a following formula 48 by using the channel estimation value input from the channel estimation unit 406a.

$$\begin{matrix}[ Expression 48 ] & \\ z = \frac{4 \sqrt{{E}_{s}}}{{N}_{0}} Re [ {\hat{h}}^{*} {y}^{( m )} ] = \sqrt{β} ( {\vert {a}^{( m )} \vert}^{2} - {\vert {b}^{( m )} \vert}^{2} ) & ( formula 48 )\end{matrix}$$

Here, a^{(m)} and b^{(m)} are independent Gaussian variables, and represented by a formula 49. Here, an average value μₐ of a and an average value μ_{b} of b in the formula 49 are provided by a formula 50, variance Nₐ of a and variance N_{b} of b are provided by a formula 51. Note that, x^{(m)} (hat) in the formulas 51 and 52 is an m-th OFDM symbol in the frame generated by the frame composition unit 805.

$$\begin{matrix} [ Expression 49 ] & \\ \{ \begin{matrix}{a}^{( m )} = \sqrt{γ} ( \hat{h} + \frac{{y}^{( m )}}{\sqrt{{E}_{s} β}} ) \\ {b}^{( m )} = \sqrt{γ} ( \hat{h} - \frac{{y}^{( m )}}{\sqrt{{E}_{s} β}} )\end{matrix} & ( formula 49 ) \\ [ Expression 50 ] & \\ \{ \begin{matrix}{μ}_{a} ( {x}^{( m )} ) = E [ a ] = \sqrt{γ} ( 1 + \frac{{x}^{( m )}}{\sqrt{{E}_{s} β}} ) h \\ {μ}_{b} ( {x}^{( m )} ) = E [ b ] = \sqrt{γ} ( 1 - \frac{{x}^{( m )}}{\sqrt{{E}_{s} β}} ) h\end{matrix} & ( formula 50 ) \\ [ Expression 51 ] & \\ \begin{matrix}{N}_{a}^{( m )} = V [ {a}^{( m )} ] = E [ {\vert {a}^{( m )} - {μ}_{a} ( {x}^{( m )} ) \vert}^{2} ] \\ = E [ {\vert \sqrt{γ} ( \hat{h} + \frac{{y}^{( m )}}{\sqrt{{E}_{s} β}} ) - {μ}_{a} ( {x}^{( m )} ) \vert}^{2} ] = \\ E [ {\vert \sqrt{γ} ( {\hat{x}}^{+} y + \frac{{y}^{( m )}}{\sqrt{{E}_{s} β}} ) - {μ}_{a} ( {x}^{( m )} ) \vert}^{2} ] \\ = E [ {\vert \sqrt{γ} ( 1 + \frac{{x}^{( m )}}{\sqrt{{E}_{s} β}} ) h + {\hat{x}}^{+} n + \frac{{n}^{( m )}}{\sqrt{{E}_{s} β}} - {μ}_{a} ( {x}^{( m )} ) \vert}^{2} ] \\ = E [ γ {\vert {\hat{x}}^{+} n + \frac{{n}^{( m )}}{\sqrt{{E}_{s} β}} \vert}^{2} ] = E [ \frac{{E}_{s}}{{N}_{0}} {\vert ( {\hat{x}}^{+} + \frac{{e}^{( m )}}{\sqrt{{E}_{s} β}} ) n \vert}^{2} ] \\ = E [ {E}_{s} {\vert {\hat{x}}^{+} + \frac{{e}^{( m )}}{\sqrt{{E}_{s} β}} \vert}^{2} ] = \frac{2}{β} ( 1 + \sqrt{\frac{1}{{E}_{s} β}} Re [ {\hat{x}}^{( m )} ] )\end{matrix} & ( formula 51 ) \\ [ Expression 52 ] & \\ {N}_{b}^{( m )} = \frac{2}{β} ( 1 - \sqrt{\frac{1}{{E}_{s} β}} Re [ {\hat{x}}^{( m )} ] ) & ( formula 52 )\end{matrix}$$

With the above average and variance, and a following formula 53, the bit LLR is able to be calculated similarly to the first embodiment. Note that, e^{(m)} is a row vector with one row and seven columns, in which an m-th element is 1 and other elements are 0, and n is a noise component vector (seven rows and one column) in each reception symbol.

$$\begin{matrix} [ Expression 53 ] & \\ \begin{matrix}{λ}_{z}^{( m )} = ln \frac{p ( z \vert {m}^{( m )} = + 1 )}{p ( z \vert {x}^{( m )} = - 1 )} \\ = ln \frac{\begin{matrix}exp ( - \frac{{\vert {μ}_{a} ( + \sqrt{{E}_{s}} ) \vert}^{2}}{{N}_{a}^{( m )}} ) {I}_{0} ( \frac{2 \vert {a}^{( m )} \vert {\vert {μ}_{a} ( + \sqrt{{E}_{s}} ) \vert}^{2}}{{N}_{a}^{( m )}} ) \\ exp ( - \frac{{\vert {μ}_{b} ( + \sqrt{{E}_{s}} ) \vert}^{2}}{{N}_{b}^{( m )}} ) {I}_{0} ( \frac{2 \vert {b}^{( m )} \vert {\vert {μ}_{b} ( + \sqrt{{E}_{s}} ) \vert}^{2}}{{N}_{b}^{( m )}} )\end{matrix}}{\begin{matrix}exp ( - \frac{{\vert {μ}_{a} ( + \sqrt{{E}_{s}} ) \vert}^{2}}{{N}_{a}^{( m )}} ) {I}_{0} ( \frac{2 \vert {a}^{( m )} \vert {\vert {μ}_{a} ( - \sqrt{{E}_{s}} ) \vert}^{2}}{{N}_{a}^{( m )}} ) \\ exp ( - \frac{{\vert {μ}_{b} ( - \sqrt{{E}_{s}} ) \vert}^{2}}{{N}_{b}^{( m )}} ) {I}_{0} ( \frac{2 \vert {b}^{( m )} \vert {\vert {μ}_{b} ( - \sqrt{{E}_{s}} ) \vert}^{2}}{{N}_{b}^{( m )}} )\end{matrix}} \\ = \frac{{\vert {μ}_{a} ( - \sqrt{{E}_{s}} ) \vert}^{2}}{{N}_{a}^{( m )}} + \frac{{\vert {μ}_{b} ( - \sqrt{{E}_{s}} ) \vert}^{2}}{{N}_{b}^{( m )}} - \frac{{\vert {μ}_{a} ( - \sqrt{{E}_{s}} ) \vert}^{2}}{{N}_{a}^{( m )}} - \\ \frac{{\vert {μ}_{b} ( - \sqrt{{E}_{s}} ) \vert}^{2}}{{N}_{b}^{( m )}} + \\ ln \frac{{I}_{0} ( \frac{2 \vert {a}^{( m )} \vert {\vert {μ}_{a} ( + \sqrt{{E}_{s}} ) \vert}^{2}}{{N}_{a}^{( m )}} ) {I}_{0} ( \frac{2 \vert {b}^{( m )} \vert {\vert {μ}_{b} ( + \sqrt{{E}_{s}} ) \vert}^{2}}{{N}_{b}^{( m )}} )}{{I}_{0} ( \frac{2 \vert {a}^{( m )} \vert {\vert {μ}_{a} ( - \sqrt{{E}_{s}} ) \vert}^{2}}{{N}_{a}^{( m )}} ) {I}_{0} ( \frac{2 \vert {b}^{( m )} \vert {\vert {μ}_{b} ( - \sqrt{{E}_{s}} ) \vert}^{2}}{{N}_{b}^{( m )}} )}\end{matrix} & ( formula 53 )\end{matrix}$$

That is, the demodulation unit 407a performs computation of the formula 53 by using the data signal, the reference signal, the average noise power spectral density and the channel estimation value, which are input from the channel estimation unit 406a, the received signal input from the data signal extraction unit 405, and the symbol input from the frame composition unit 805, and performs output as the bit LLR to the de-interleave unit 408. For example, in a case where the channel estimation method is the LS channel estimation, power capable of being used for channel estimation is Eₚ when iteration is not made, while it is possible to increase the power by the number of pieces of data subjected to hard decision, so that channel estimation error (MSE) becomes as shown in a formula 54.

$$\begin{matrix}[ Expression 54 ] & \\ {σ}_{est}^{2} = \frac{{N}_{0}}{{E}_{p} + \hat{M} {E}_{s}} & ( formula 54 ) \\ [ Expression 55 ] & \\ β = \frac{{E}_{p} + \hat{M} {E}_{s}}{{E}_{s}} & ( formula 55 )\end{matrix}$$

Here, though decision error at the time of hard decision is not considered in the formula 54, correction may be performed by considering a parameter such as an empirical error rate. A soft-decision value may be used for making the decision error less vulnerable.

As above, the terminal device 102a in the present embodiment is able to improve accuracy of channel estimation by using the iterative channel estimation as well as to suppress error included in the bit LLR which is a result of demodulation processing. By performing error decision and error correction decoding by using the LLR, it is possible to improve a bit error rate compared to a case where the conventional LLR calculation method is used.

Description has been given in the present embodiment by exemplifying the method for using the LLR of data only for channel estimation. When there is interference such as inter-symbol interference or inter-stream interference in MIMO, however, processing of using the LLR of data for channel estimation and also for generation of a replica of the interference for subtracting from a received signal, thereby cancelling the interference may be applied.

### Modified Example 1

Though a case where BPSK is used as the modulation method has been described above, description will be given as a modified example 1 for processing of the modulation unit 407a when the modulation method of data is the QPSK in the iterative channel estimation, that is, the modulation unit 203 generates a modulation symbol by the QPSK. When the modulation method is the QPSK, two bits forming a QPSK symbol are respectively c0 and c1. In this case, a transmission data symbol x_{d}ε{χ₀, χ₁, χ₂, χ₃} is represented by a following formula 56.

[Expression 56]

x_{d}=\sqrt{Eₛ/2}{(2c₀−1)+j(2c₁−1)} (formula 56)

A bit LLR of c₀ in an m-th OFDM symbol of a k-th subcarrier at the time of iterative channel estimation is able to be put as shown in a following formula 57.

$$\begin{matrix}[ Expression 57 ] & \\ \begin{matrix}{z}_{0}^{( m )} = ln \frac{p ( {y}^{( m )} \vert {c}_{0} = 1 )}{p ( {y}^{( m )} \vert {c}_{0} = 0 )} \\ = \frac{2 \sqrt{2 {E}_{s}}}{{N}_{0}} Re [ {\hat{h}}^{*} {y}^{( m )} ] \\ = \sqrt{β} ( {\vert {a}^{( m )} \vert}^{2} - {\vert {b}^{( m )} \vert}^{2} )\end{matrix} & ( formula 57 )\end{matrix}$$

Here, a^{(m)} and b^{(m)} are independent Gaussian variables, and represented by a formula 58. Here, an average value μₐ and variance Nₐ of a^{(m)} are provided by a formula 59, and an average value μ_{b} and variance N_{b} of b^{(m)} are represented by a formula 60.

$$\begin{matrix}[ Expression 58 ] & \\ \{ \begin{matrix}{a}^{( m )} = {2}^{- \frac{1}{4}} \sqrt{γ} ( \hat{h} + \frac{{y}^{( m )}}{\sqrt{{E}_{s} β}} ) \\ {b}^{( m )} = {2}^{- \frac{1}{4}} \sqrt{γ} ( \hat{h} - \frac{{y}^{( m )}}{\sqrt{{E}_{s} β}} )\end{matrix} & ( formula 58 ) \\ [ Expression 59 ] & \\ \{ \begin{matrix}{μ}_{a} ( {x}_{d} ) = E [ a ] = {2}^{- \frac{1}{4}} \sqrt{γ} ( 1 + \frac{{x}^{( m )}}{\sqrt{{E}_{s} β}} ) h \\ {N}_{a} = V [ a ] = \frac{\sqrt{2}}{β} ( 1 + \sqrt{\frac{1}{{E}_{s} β}} Re [ {\hat{x}}^{( m )} ] )\end{matrix} & ( formula 59 ) \\ [ Expression 60 ] & \\ \{ \begin{matrix}{μ}_{b} ( {x}_{d} ) = E [ b ] = {2}^{- \frac{1}{4}} \sqrt{γ} ( 1 - \frac{{x}^{( m )}}{\sqrt{{E}_{s} β}} ) h \\ {N}_{b} = V [ b ] = \frac{\sqrt{2}}{β} ( 1 - \sqrt{\frac{1}{{E}_{s} β}} Re [ {\hat{x}}^{( m )} ] )\end{matrix} & ( formula 60 )\end{matrix}$$

With the above average and variance, a following formula 61 is obtained similarly to calculation of the formula 53. The demodulation unit 407a uses the formula 61 as formula of calculating the LLR of the bit c₀. Here, f(x_{q}) in the formula 61 is represented by a formula 62.

$$\begin{matrix} [ Expression 61 ] & \\ {λ}_{z , 0}^{( m )} = ln \frac{f ( {χ}_{2} ) + f ( {χ}_{3} )}{f ( {χ}_{0} ) + f ( {χ}_{1} )} = ln \frac{f ( {χ}_{2} )}{f ( {χ}_{0} )} & ( formula 61 ) \\ [ Expression 62 ] & \\ f ( {X}_{q} ) = exp ( - \frac{{\vert {μ}_{a} ( {χ}_{q} ) \vert}^{2}}{{N}_{a}^{( m )}} - \frac{{\vert {μ}_{b} ( {χ}_{q} ) \vert}^{2}}{{N}_{b}^{( m )}} ) {I}_{0} ( \frac{2 \vert {a}^{( m )} \vert {\vert {μ}_{a} ( {χ}_{q} ) \vert}^{2}}{{N}_{a}^{( m )}} ) {I}_{0} ( \frac{2 \vert {b}^{( m )} \vert {\vert {μ}_{b} ( {χ}_{q} ) \vert}^{2}}{{N}_{b}^{( m )}} ) & ( formula 62 )\end{matrix}$$

Next, the bit c₁ will be described. A bit LLR of c₁ in the m-th OFDM symbol of the k-th subcarrier at the time of iterative channel estimation is able to be put as shown in a following formula 63.

$$\begin{matrix}[ Expression 63 ] & \\ \begin{matrix}{z}_{1}^{( m )} = ln \frac{p ( {y}^{( m )} \vert {c}_{1} = 1 )}{p ( {y}^{( m )} \vert {c}_{1} = 0 )} \\ = \frac{2 \sqrt{2 {E}_{s}}}{{N}_{0}} Im [ {\hat{h}}^{*} {y}^{( m )} ] \\ = \sqrt{β} ( {\vert {a}^{( m )} \vert}^{2} - {\vert {b}^{( m )} \vert}^{2} )\end{matrix} & ( formula 63 )\end{matrix}$$

Here, a^{(m)} and b^{(m)} are independent Gaussian variables, and represented by a formula 64. An average value μₐ and variance Nₐ of a^{(m)} are provided by a formula 65, and an average value μ_{b} and variance N_{b} of b^{(m)} are provided by a formula 66.

$$\begin{matrix}[ Expression 64 ] & \\ \{ \begin{matrix}{a}^{( m )} = {2}^{- \frac{1}{4}} \sqrt{γ} ( \hat{h} - j \frac{{y}^{( m )}}{\sqrt{{E}_{s} β}} ) \\ {b}^{( m )} = {2}^{- \frac{1}{4}} \sqrt{γ} ( \hat{h} + j \frac{{y}^{( m )}}{\sqrt{{E}_{s} β}} )\end{matrix} & ( formula 64 ) \\ [ Expression 65 ] & \\ \{ \begin{matrix}{μ}_{a} ( {x}_{d} ) = E [ a ] = {2}^{- \frac{1}{4}} \sqrt{γ} ( h - j \frac{{x}^{( m )}}{\sqrt{{E}_{s} β}} ) h \\ {N}_{a} = V [ a ] = \frac{\sqrt{2}}{β} ( 1 + \sqrt{\frac{1}{{E}_{s} β}} Im [ {\hat{x}}^{( m )} ] )\end{matrix} & ( formula 65 ) \\ [ Expression 66 ] & \\ \{ \begin{matrix}{μ}_{a} ( {x}_{d} ) = e [ a ] = {2}^{- \frac{1}{4}} \sqrt{γ} ( h - j \frac{{x}^{( m )}}{\sqrt{{E}_{s} β}} ) h \\ {N}_{a} = V [ a ] = \frac{\sqrt{2}}{β} ( 1 + \sqrt{\frac{1}{{E}_{s} β}} Im [ {\hat{x}}^{( m )} ] )\end{matrix} & ( formula 66 )\end{matrix}$$

With the above average and variance, a following formula 67 is obtained similarly to calculation of the formula 53. The demodulation unit 407 uses the formula 67 as a formula of calculating the LLR of the bit c₁.

$$\begin{matrix}[ Expression 67 ] & \\ {λ}_{z , 1}^{( m )} = ln \frac{f ( {χ}_{1} ) + f ( {χ}_{3} )}{f ( {χ}_{0} ) + f ( {χ}_{2} )} = ln \frac{f ( {χ}_{1} )}{f ( {χ}_{0} )} & ( formula 67 )\end{matrix}$$

In this manner, the demodulation unit 407a is able to calculate the LLRs of each of the bits (c₀ and c₁) of the QPSK by the formula 61 and the formula 67, respectively. The similar is also applicable when another modulation method such as 16 QAM (Quadrature Amplitude Modulation) is used,

### Modified Example 2

Description has been given in the second embodiment and the modified example 1 thereof for the case where the LS channel estimation is used as the channel estimation method during iterative channel estimation. However, a new LLR calculation method at the time of the iterative channel estimation is used in the present embodiment, but the channel estimation method performed during the iterative channel estimation may be any one without limitation to the LS channel estimation. Thus, as another channel estimation method, an LLR calculation method when channel estimation with a noise eliminated (NE) reference will be described.

The channel estimation with the NE reference itself has been described in the modified example 2 of the first embodiment, so that description thereof will be omitted. In the case of the LS channel estimation, a channel estimation error (MSE) in the iterative channel estimation is represented by the formula 54, and an influence of noise is able to be set as L/K in the channel estimation with the NE reference. That is, the channel estimation error (MSE) in the channel estimation with the NE reference is represented by a formula 68. Accordingly, β is able to be calculated by a formula 69.

$$\begin{matrix}[ Expression 68 ] & \\ {σ}_{est}^{2} = \frac{L}{K} \frac{{N}_{0}}{{E}_{p} + \hat{M} {E}_{s}} & ( formula 68 ) \\ [ Expression 69 ] & \\ β = \frac{K}{L} \frac{{E}_{p} + \hat{M} {E}_{s}}{{E}_{s}} & ( formula 69 )\end{matrix}$$

By using a value of the formula 69 instead of the formula 55, it is possible to suppress error included in the bit LLR which is a result of demodulation processing at the time of the iterative channel estimation using the NE channel estimation as well.

### Third Embodiment

In the second embodiment, when channel estimation is performed, all data sequences obtained in previous demodulation were used. On the other hand, the likelihood which has been obtained in the previous demodulation is obtained also in next demodulation and is therefore not generally reflected on iteration, and an external LLR is exchanged between two decoders also in turbo decoding. Thus, described in a third embodiment is processing of the channel estimation unit 406a and processing of the demodulation unit 407a when an external replica symbol is used in the iterative channel estimation. Note that, a frame composition and the like in the present embodiment are similar to those of the second embodiment.

In the present embodiment, an external symbol replica is defined. The external symbol replica x^{(m)} (hat) which is used when a channel estimation value for an m-th OFDM is obtained is represented by a following formula 70.

[Expression 70])

\hat{x}₍ₘ₎=[\hat{x}⁽¹⁾\hat{x}₍₂₎ . . . \hat{x}^{(m-1)}0\hat{x}^{(m+1)} . . . \hat{x}⁽⁷⁾]^{T} (formula 70)

That is, a value of the x^{(m)} (hat) is set as 0 in the formula 47. Thereby, the likelihood which has been obtained in previous demodulation is not to be used again in next demodulation. A vector of a following formula 71 is calculated from the obtained external symbol replica. In the formula 71, M^{(m)} (hat) is the number of non-zero elements of x (hat) (maximum, 13).

$$\begin{matrix}[ Expression 71 ] & \\ {\hat{x}}^{( m ) +} = \frac{1}{{E}_{p} + {\hat{M}}^{( m )} {E}_{s}} {\hat{x}}^{( m ) H} & ( formula 71 )\end{matrix}$$

As described above, since the value of x^{(m)} (hat) is set as 0, a value of variance is as shown in a following formula 72 with the formula 65 and the formula 66.

$$\begin{matrix}[ Expression 72 ] & \\ {N}_{ab}^{( m )} = V [ {a}^{( m )} ] = V [ {b}^{( m )} ] = \frac{2}{β} & ( formula 72 )\end{matrix}$$

Since a and b have the same variance, the LLR is represented by a formula 73. That is, the demodulation unit 407a calculates the LLR by using the formula 73.

$$\begin{matrix} [ Expression 73 ] & \\ {λ}_{z}^{( m )} = ln \frac{{I}_{0} ( \frac{2 \vert {a}^{( m )} \vert {\vert {μ}_{a} ( + \sqrt{{E}_{s}} ) \vert}^{2}}{{N}_{a}^{( m )}} ) {I}_{0} ( \frac{2 \vert {b}^{( m )} \vert {\vert {μ}_{b} ( + \sqrt{{E}_{s}} ) \vert}^{2}}{{N}_{b}^{( m )}} )}{{I}_{0} ( \frac{2 \vert {a}^{( m )} \vert {\vert {μ}_{a} ( - \sqrt{{E}_{s}} ) \vert}^{2}}{{N}_{a}^{( m )}} ) {I}_{0} ( \frac{2 \vert {b}^{( m )} \vert {\vert {μ}_{b} ( - \sqrt{{E}_{s}} ) \vert}^{2}}{{N}_{b}^{( m )}} )} & ( formula 73 )\end{matrix}$$

In this manner, simplification is attained in the above formula 73 compared to the formula 53. For example, in the case of the LS channel estimation, the channel estimation unit 406a calculates a channel estimation value by using a following formula 74.

$$\begin{matrix}[ Expression 74 ] & \\ \begin{matrix}{\hat{h}}_{LS}^{( m )} = {\hat{x}}^{( m ) +} y \\ = \{ \begin{matrix}\frac{\hat{M}}{{\hat{M}}^{( m )}} {\hat{h}}_{LS} - \frac{1}{{\hat{M}}^{( m )}} \frac{{y}^{( m )}}{{\hat{x}}^{( m )}} , & ( {\hat{x}}^{( m )} \neq 0 ) \\ {\hat{h}}_{LS} , & ( {\hat{x}}^{( m )} = 0 )\end{matrix}\end{matrix} & ( formula 74 )\end{matrix}$$

The above formula 74 shows that when the external symbol replica is used, the channel estimation value obtained from a data signal in the m-th OFDM symbol may be merely subtracted from the channel estimation value used in the second embodiment. Moreover, a value of β^{(m)} at the time of the channel estimation of the m-th OFDM symbol is represented by a following formula 75.

$$\begin{matrix}[ Expression 75 ] & \\ {β}^{( m )} = \frac{{E}_{p} + {\hat{M}}^{( m )} {E}_{s}}{{E}_{s}} & ( formula 75 )\end{matrix}$$

Further, when the channel estimation method is the channel estimation with the NE reference, the channel estimation unit 406a calculates the channel estimation value by using a following formula 76.

$$\begin{matrix}[ Expression 76 ] & \\ \begin{matrix}{\hat{h}}_{LS}^{( m )} = {\hat{x}}^{( m ) +} y \\ = \{ \begin{matrix}\frac{\hat{M}}{{\hat{M}}^{( m )}} {\hat{h}}_{LS} - \frac{1}{K {\hat{M}}^{( m )}} \frac{{y}^{( m )}}{{\hat{x}}^{( m )}} , & ( {\hat{x}}^{( m )} \neq 0 ) \\ {\hat{h}}_{LS} , & ( {\hat{x}}^{( m )} = 0 )\end{matrix}\end{matrix} & ( formula 76 )\end{matrix}$$

The above formula 76 shows that when the external symbol replica is used, the channel estimation value obtained from the data signal in the m-th OFDM symbol may be merely subtracted from the channel estimation value used in the second embodiment. Moreover, a value of β^{(m)} at the time of the channel estimation of the m-th OFDM symbol is represented by a following formula 77.

$$\begin{matrix}[ Expression 77 ] & \\ {β}^{( m )} = \frac{K}{L} \frac{{E}_{p} + {\hat{M}}^{( m )} {E}_{s}}{{E}_{s}} & ( formula 77 )\end{matrix}$$

In this manner, by using the external symbol replica in the iterative channel estimation, an influence by the previous channel estimation is not accumulated in the channel estimation value in the OFDM, thus making it possible to perform appropriate iterative processing based on turbo principle. As a result thereof, accuracy of the iterative channel estimation is improved, thus making it possible to improve transmission performance. Further, since the calculation of the LLR is to be performed based on the formula 73, calculation of an index becomes unnecessary, thus making it possible to reduce an amount of calculation significantly compared to the formula 53 of the second embodiment.

A program which is operated in the base station device and the terminal device related to each of the embodiments and modified examples thereof described above is a program which controls a CPU and the like (program that causes a computer to function) so as to realize functions of the base station device and the terminal device in each of the embodiments and modified examples thereof described above. In addition, information which is handled by the devices is temporarily accumulated in a RAM at the time of processing thereof, and then stored in various ROMs or an HDD, and is read, modified, and written by the CPU as necessary. A recording medium that stores the program may be any of a semiconductor medium (for example, a ROM, a nonvolatile memory card or the like), an optical recording medium (for example, a DVD, an MO, an MD, a CD, a BD or the like) or a magnetic recording medium (for example, a magnetic tape, a flexible disc or the like). Moreover, there is a case where, by executing the loaded program, not only the functions of the embodiments described above are realized, but also by performing processing in cooperation with an operating system, other application programs or the like based on an instruction of the program, the functions of the invention are realized.

When being distributed in the market, the program is able to be stored in a portable recording medium and distributed or be transferred to a server computer connected through a network such as the Internet. In this case, a storage device of the server computer is also included in the invention. A part or all of the base station device and the terminal device in the embodiments described above may be realized as an LSI which is a typical integrated circuit. Each functional block of the base station device and the terminal device may be individually formed into a chip, or a part or all thereof may be integrated and formed into a chip. Further, a method for making into an integrated circuit is not limited to the LSI and a dedicated circuit or a versatile processor may be used for realization.

When each functional block is made into an integrated circuit, an integrated circuit control unit for controlling them is added.

Further, a method for making into an integrated circuit is not limited to the LSI and a dedicated circuit or a versatile processor may be used for realization. In a case where a technique for making into an integrated circuit in place of the LSI appears with advance of a semiconductor technology, an integrated circuit by the technique may be also used.

The invention of the present application is not limited to the embodiments described above. The terminal device of the invention of the present application is not limited to be applied to a mobile station device, but, needless to say, is applicable to stationary or unmovable electronic equipment which is installed indoors or outdoors such as, for example, AV equipment, kitchen equipment, a cleaning/washing machine, air conditioning equipment, office equipment, an automatic vending machine, other domestic equipment, and the like.

As above, the embodiments of the invention have been described in detail with reference to drawings, but specific configurations are not limited to the embodiments, and a design change and the like within a scape which is not departed from the main subject of the invention are also included. The invention can be modified variously within the scope defined by the claims, and embodiments obtained by appropriately combining technical means disclosed in different embodiments are also included in the technical scope of the invention. The configuration in which elements described in each of the aforementioned embodiments and achieving similar effects are replaced with each other is also included.

(1) One aspect of the invention is a reception device including: a reception unit for receiving a signal representing a bit sequence; a channel estimation unit for estimating channel variation that the signal undergoes and calculating a channel estimation value representing the channel variation; and a demodulation unit for demodulating the signal by using the channel estimation value and restoring each bit included in the bit sequence, in which the demodulation unit performs demodulation of the signal by using a value indicating magnitude of error included in the channel estimation value.

(2) Another aspect of the invention is the reception device according to (1), in which the demodulation unit may perform the demodulation by using a probability density function that is a probability density function of the signal and that is a product of two probability density functions each represents a corresponding independent Gaussian variable by using at least the signal and the value indicating the magnitude of the error.

(3) Another aspect of the invention is the reception device according to (1) or (2), which may include a decoding unit for performing error correction decoding for the bit restored by the demodulation unit by using a state transition probability according to reception power of the signal.

(4) Another aspect of the invention is the reception device according to any one of (1) to (3), which may include a decoding unit for performing error correction decoding for the bit restored by the demodulation unit; and a replica generation unit for generating a replica of a transmission symbol by using the bit subjected to the error correction decoding, and in which channel estimation by the channel estimation unit, demodulation by the demodulation unit, error correction decoding by the decoding unit and generation of the replica by the replica generation unit are performed iteratively, and the channel estimation unit performs channel estimation by using the replica generated by the replica generation in second and subsequent times of the iteration.

(5) Another aspect of the invention is the reception device according to any one of (1) to (4), in which the channel estimation unit calculates, for each reception symbol included in the received signal, a channel estimation value used for demodulating the reception symbol, and a channel estimation value used for demodulating a first reception symbol is a value obtained by performing channel estimation without using a replica of a transmission symbol of the first reception symbol.

(6) Another aspect of the invention is a reception method, including: a first step of receiving a signal representing a bit sequence; a second step of estimating channel variation that the signal undergoes and calculating a channel estimation value representing the channel variation; and a third step of demodulating the signal by using the channel estimation value and restoring each bit included in the bit sequence, in which demodulation of the signal is performed by using a value indicating magnitude of error included in the channel estimation value at the third step.

One aspect of the invention is applicable to, for example, a reception device which needs to suppress error included in a bit LLR obtained by demodulation using a channel estimation value.

### REFERENCE SIGNS LIST

10 communication system
101 base station device
102, 102a terminal device
201 coding unit
202 interleave unit
203 modulation unit
204 reference signal generation unit
205 frame composition unit
206 IFFT unit
207 CP insertion unit
208 radio transmission unit
209 transmit antenna
401 receive antenna
402 radio reception unit
403 CP removal unit
404 FFT unit
405 data signal extraction unit
406, 406a channel estimation unit
407, 407a demodulation unit
408 de-interleave unit
409, 409a decoding unit
501 MSE setting unit
502 first variable calculation unit
503 absolute value acquisition unit
504 second variable calculation unit
505 absolute value acquisition unit
506 absolute value acquisition unit
507 LLR calculation unit
801 interleave unit
802 replica generation unit
803 replica absolute value correction unit
804 reference signal generation unit

What is claimed is:

1. A reception device, comprising:
a reception unit for receiving a signal representing a bit sequence;
a channel estimation unit for estimating channel variation that the signal undergoes and calculating a channel estimation value representing the channel variation; and
a demodulation unit for demodulating the signal by using the channel estimation value and restoring each bit included in the bit sequence, wherein
the demodulation unit performs demodulation of the signal by using a value indicating magnitude of error included in the channel estimation value.

2. The reception device according to claim 1, wherein the demodulation unit performs the demodulation by using a probability density function that is a probability density function of the signal and that is a product of two probability density functions each represents a corresponding independent Gaussian variable by using at least the signal and the value indicating the magnitude of the error.

3. The reception device according to claim 1, further comprising:
a decoding unit for performing error correction decoding for the bit restored by the demodulation unit by using a state transition probability according to reception power of the signal.

4. The reception device according to claim 1, further comprising:
a decoding unit for performing error correction decoding for the bit restored by the demodulation unit; and
a replica generation unit for generating a replica of a transmission symbol by using the bit subjected to the error correction decoding, wherein
channel estimation by the channel estimation unit, demodulation by the demodulation unit, error correction decoding by the decoding unit and generation of the replica by the replica generation unit are performed iteratively, and
the channel estimation unit performs channel estimation by using the replica generated by the replica generation in second and subsequent times of the iteration.

5. The reception device according to claim 1, wherein the channel estimation unit calculates, for each reception symbol included in the received signal, a channel estimation value used for demodulating the reception symbol, and a channel estimation value used for demodulating a first reception symbol is a value obtained by performing channel estimation without using a replica of a transmission symbol of the first reception symbol.

6. A reception method, comprising:
a first step of receiving a signal representing a bit sequence;
a second step of estimating channel variation that the signal undergoes and calculating a channel estimation value representing the channel variation; and
a third step of demodulating the signal by using the channel estimation value and restoring each bit included in the bit sequence, wherein
demodulation of the signal is performed by using a value indicating magnitude of error included in the channel estimation value at the third step.
